(19) United States
(12) Patent Application Publication
(10) Pub. No.: US 2008/0071600 A1
(43) Pub. Date: Mar. 20, 2008

(54) Systems and methods for automating business services

(76) Inventor: Kenneth N. Johnson, Greensboro, NC (US)

Correspondence Address: KILPATRICK STOCKTON LLP, 1001 WEST FOURTH STREET, WINSTON-SALEM, NC, 27101, US

(21) Appl. No.: 11/894,516

(22) Filed: Aug. 21, 2007

Related U.S. Application Data
(60) Provisional application No. 60/839,327, filed on Aug. 21, 2006.
(60) Provisional application No. 60/839,326, filed on Aug. 21, 2006.

(51) Int. Cl. G06Q 40/00; G06Q 10/00

(52) U.S. Cl. 705/9; 705/30; 705/31; 705/7

(57) ABSTRACT

Systems and computer implemented methods of managing a plurality of tasks is described. The system includes a module to receive a request by the system for a service. The module further includes a module to divide the service into an at least one task of the plurality of tasks on the system. The module further includes a module to assign a subgroup of the at least one task to a specialist. In addition, systems and methods for automatically determining a settlement payment option is described. The system includes a module to receive a personal information for a client. The system further includes a module to calculate a monthly disposable income from the personal information. The system further includes a module to calculate an estimated installment payment from the monthly disposable income.

### CROSS-REFERENCES TO RELATED APPLICATION

This application claims priority to U.S. Provisional Patent Application No. 60/839,327 filed Aug. 21, 2006, entitled “TaskMaster System, Methods and Processes Associated Therewith,” and U.S. Provisional Patent Application No. 60/839,326 filed Aug. 21, 2006, entitled “Peace of Mind Options Analysis System and Methods,” the entirety of which are hereby incorporated by reference.

### FIELD OF THE INVENTION

The present invention relates to systems and methods for automating business services. The present invention more particularly relates to automating tasks associated with tax preparation and/or tax filings and/or other tax related functions in a business enviromnent.

### BACKGROUND

Traditionally, the act of engaging and finding clients for which a business establishment desires to do work involved face to face meetings and/or telephonic meetings. Once clients were engaged, a clients needs were ascertained. Those needs were typically set out in a written contract involving the application of pen to paper, or more recently, the contract printed from a computer using word processing or some other text capture means. Once the contract was signed by the client, management in the business establishment would manually assign tasks to the business employees to complete the tasks that were laid out in the contract. All of these services are still performed in the business environment today.

For one example client service, most disputes between a taxpayer and the Internal Revenue Service (IRS) are settled or compromised in some way. In determining a tax settlement between the taxpayer and the IRS, almost an infinite number of variables may be present in a tax dispute settlement. Some of these factors may weigh in favor of an unfavorable settlement while other factors may weigh in favor of a favorable settlement for a taxpayer. Once a settlement agreement is reached, a realistic set of settlement option payments based on the client's financial situation, current tax code, and IRS regulations is desired. Traditionally, the settlement option payments are manually determined by a worker in a labor intensive process.

However, in the competitive business environment that is present in today's business world, it is desired that a broader and more efficient means of engaging clients and processing those clients' needs, such as determining settlement option payments, is desired. Thus, the present invention relates to a more efficient means of providing the above described client services.

### SUMMARY

The present invention relates to systems and methods of automatically managing tasks and/or workload in a business environment. In an embodiment of the present invention, the present invention relates to using an interactive software interface to manage tasks associated with tax preparation and/or tax filings and/or other tax related functions in a business environment.

Furthermore, the present invention relates to systems and methods for automatically determining the correct collection potential of a taxpayer according to IRS guidelines. The present invention further relates to systems and methods for automatically recommending a realistic set of settlement options based on the client's financial situation (collection potential), current tax code, and/or IRS regulations. In one embodiment, the present invention relates to a software application for calculating the above-described settlement options.

### BRIEF DESCRIPTION OF THE DRAWINGS

These and other features, aspects, and advantages of the present invention are better understood when the following Detailed Description is read with reference to the accompanying drawings, wherein:

FIG. 1 shows an exemplary system of an embodiment of the present invention for automating engaging clients and ascertaining/managing the tasks that will be done for those clients.

FIG. 2 shows an exemplary method for automatically engaging clients and ascertaining/managing tasks for those clients by the system in FIG. 1.

FIG. 3 shows a snapshot of a service selection and pricing screen of an example client interface for sending engagement requests to the system of FIG. 1.

FIG. 4 shows a snapshot of a sales meeting screen of an example client interface for sending engagement requests to the system of FIG. 1.

FIG. 5 shows a snapshot of an engagement assignment screen of an example interface for dividing and assigning tasks by the system of FIG. 1.

FIG. 6 shows a snapshot of a task management screen of an example interface for the system of FIG. 1 to manage workload and assist in the completion of tasks by specialists/workers.

FIG. 7 shows a snapshot of a case management screen of an example interface for the system of FIG. 1 to inform a worker of engagement information.

FIG. 8 shows a snapshot of a case management screen of an example interface for the system of FIG. 1 to inform a worker of engagement information.

FIG. 9 shows an example method of the system in FIG. 1 to determine a tax settlement payment schedule and structure for a client.

FIG. 10 shows an example Tax Settlement Analysis of a client based on the client's financial situation, current tax code, and IRS regulations.

FIG. 11 shows an exemplary computer system for implementing embodiments of the system in FIG. 1.

### DETAILED DESCRIPTION

The present invention relates to systems and methods of automatically managing tasks and/or workloads in a business environment. In one embodiment, the present invention relates to systems and methods of automating engaging clients, ascertaining the work that should be and will be done for those clients, and/or setting out a means for accomplishing that work using an optional interactive computer environment that can optionally be accessed by employees and management of both the business establishment and/or the client. In addition, an embodiment of the present invention relates to automatically determining a tax settlement analysis payment schedule and/or the collection potential of a client.

### Task Management

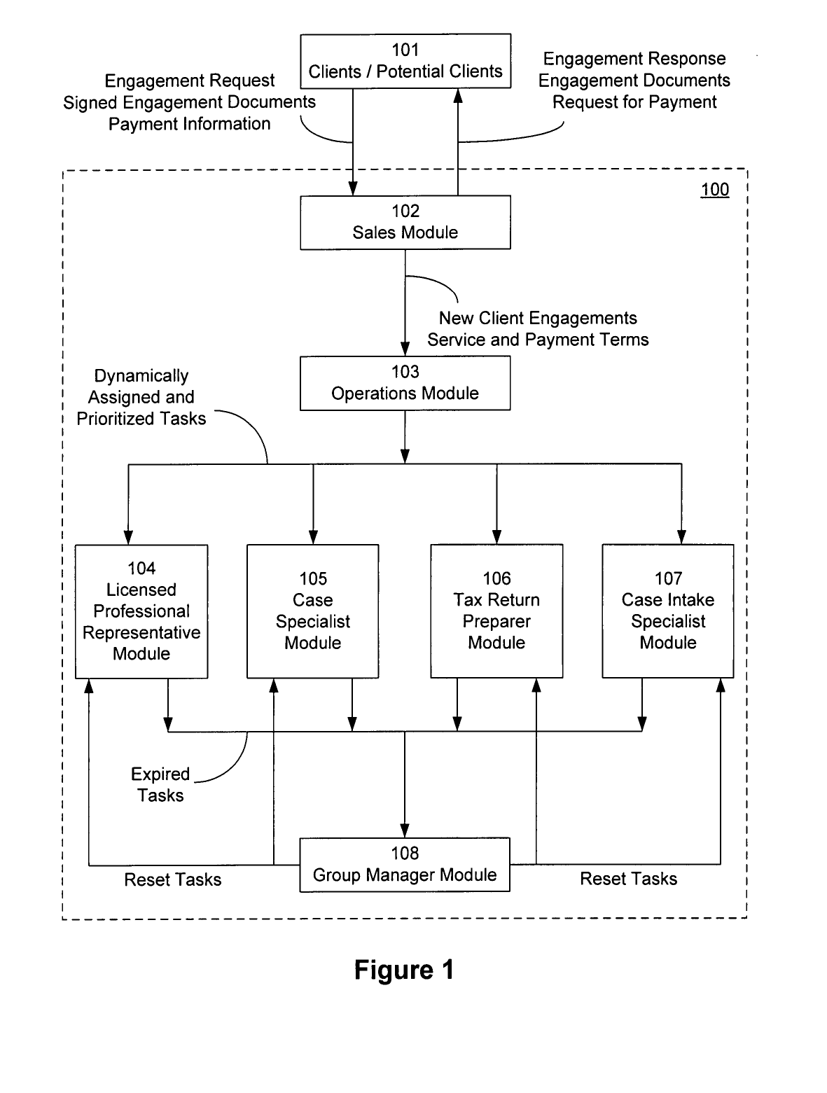

FIG. 1 illustrates an exemplary system 100 of an embodiment of the present invention for automating engaging clients 101 and ascertaining/managing the work that should be and will be done for those clients 101. The system 100 generally includes: a sales module 102 for interfacing with the client/potential client 101 and/or the worker assisting the client to compose an engagement letter; an operations module 103 for dividing, assigning, and prioritizing the list of tasks in newly received engagement letters; a Licensed Professional Representative (LPR) module 104, Case Specialist module 105, Tax Return Preparer module 106, and Case Intake Specialist module 107 for receiving tasks from the Operations module 103 and assisting the specific specialist in completing those tasks; and a Group Manager module 108 for supervising the completion of tasks and resetting and returning any tasks to assistance modules 104-107 that need further processing.

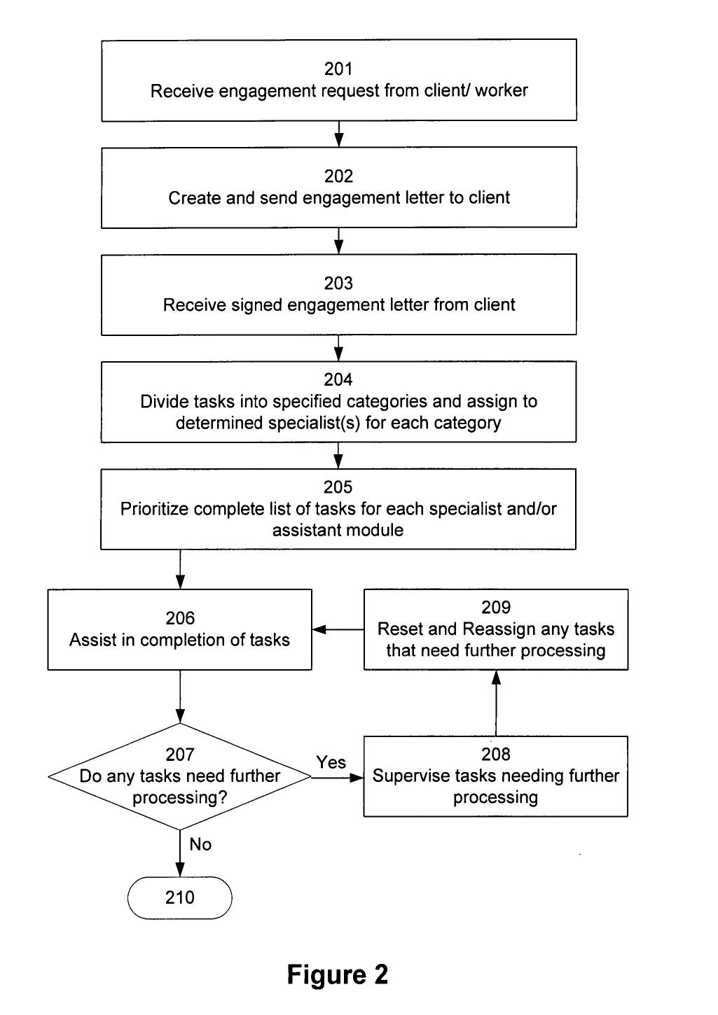

FIG. 2 illustrates an exemplary method for automatically engaging clients and ascertaining/managing tasks for those clients by the system 100 in FIG. 1. Beginning at 201, the sales module 102 (FIG. 1) receives an engagement request from a potential client 101 or worker. In one embodiment, the interface by the sales module 102 with the potential client 101 is an Internet application that the potential client may access through a web browser on the internet. In another embodiment, the client may call a worker for the company (e.g., a customer service representative) and the worker interacts with an internal or internet application for the sales module 102 on behalf of the potential client 101.

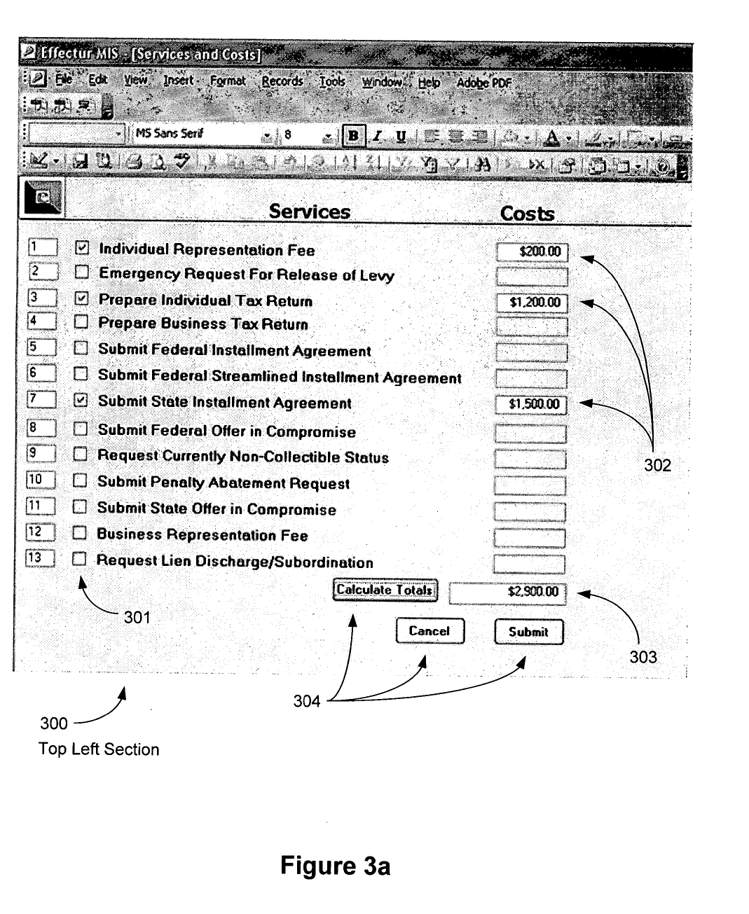

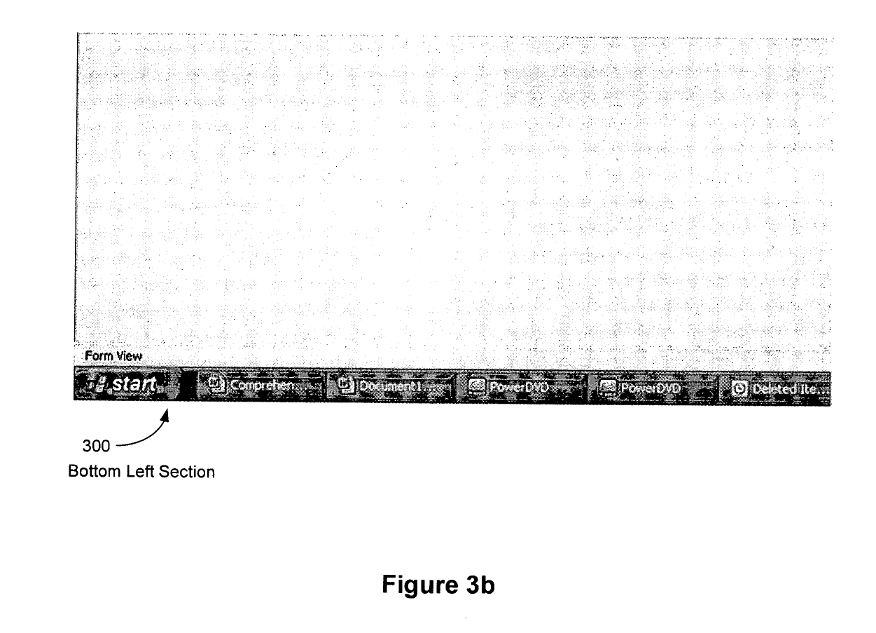

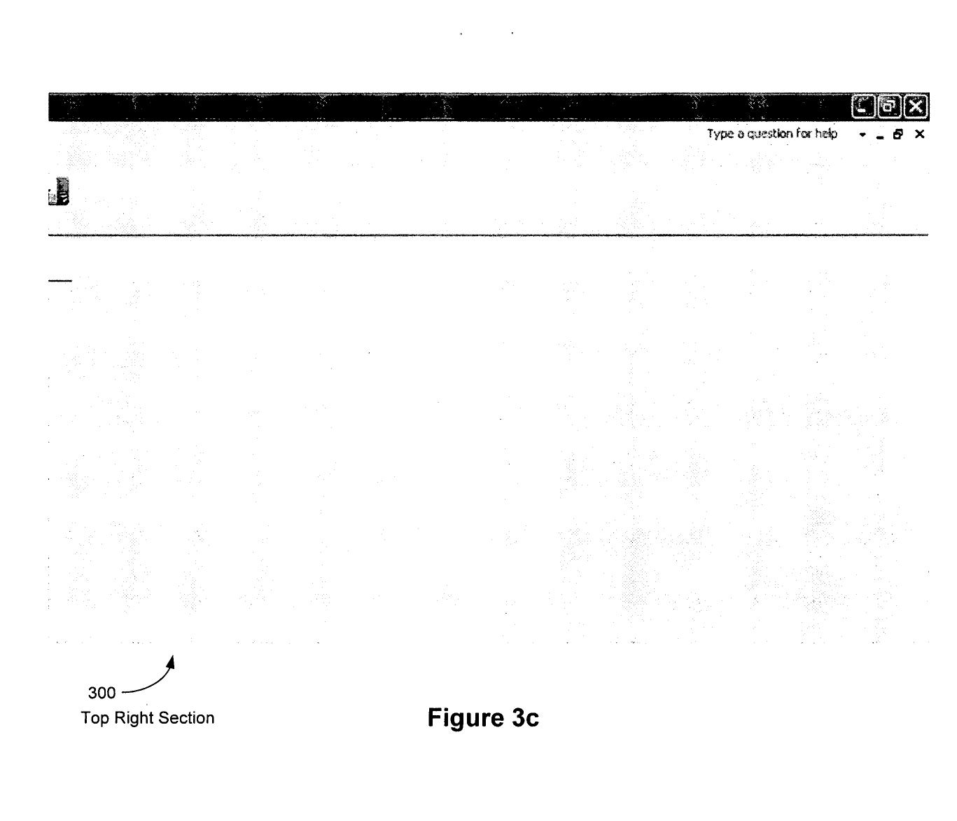

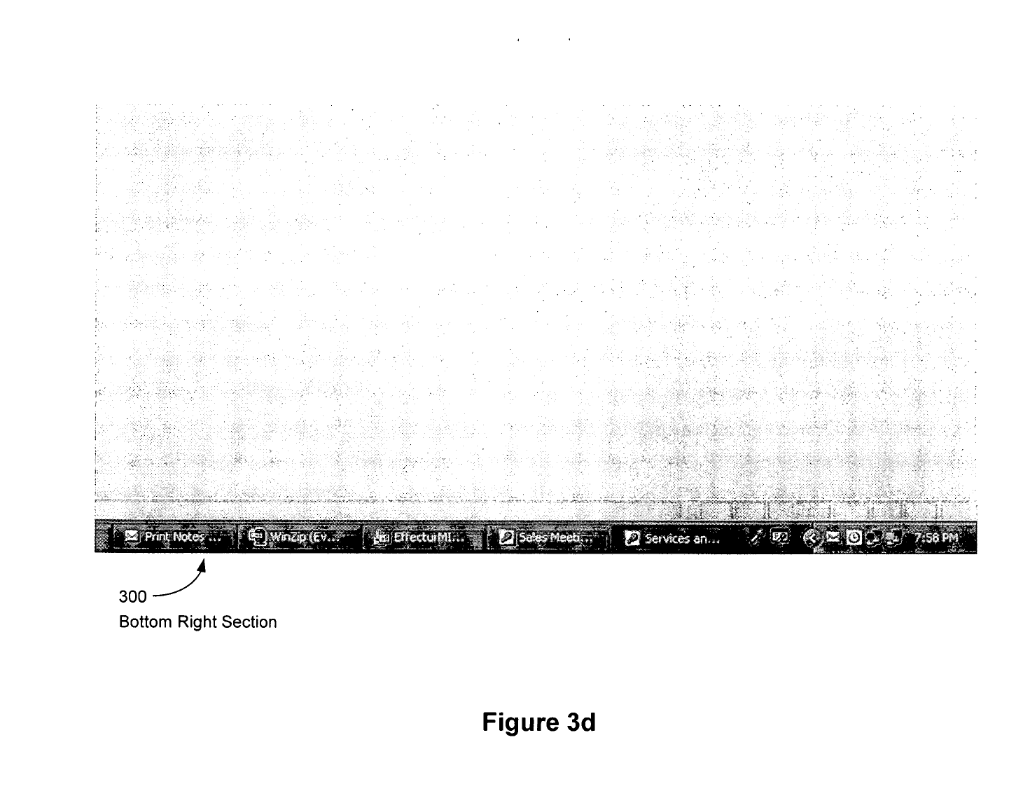

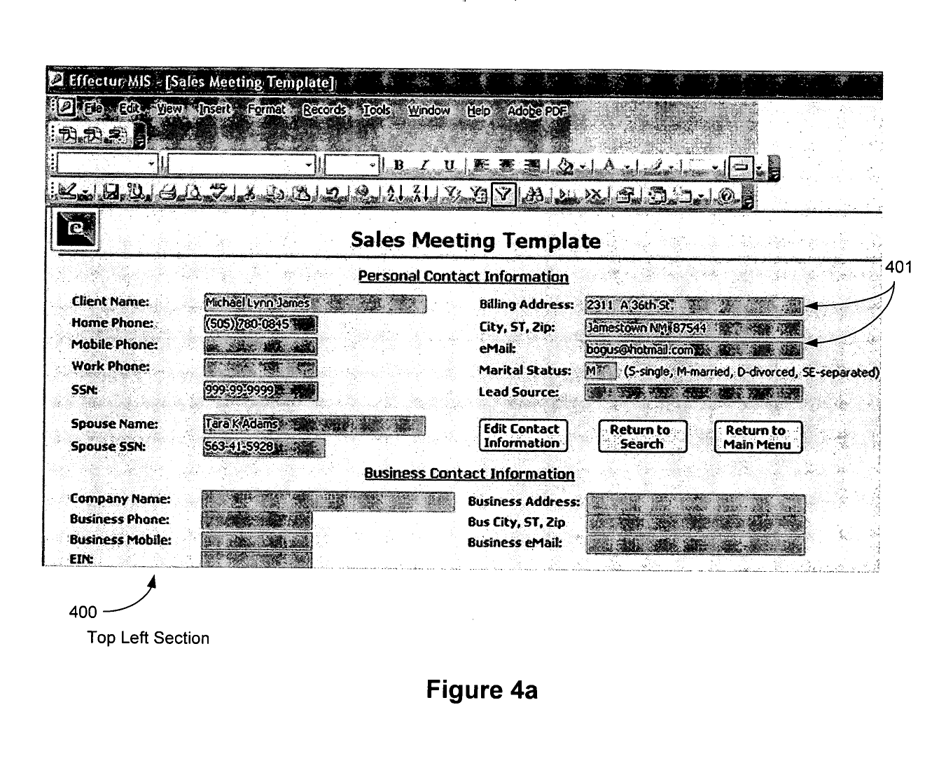

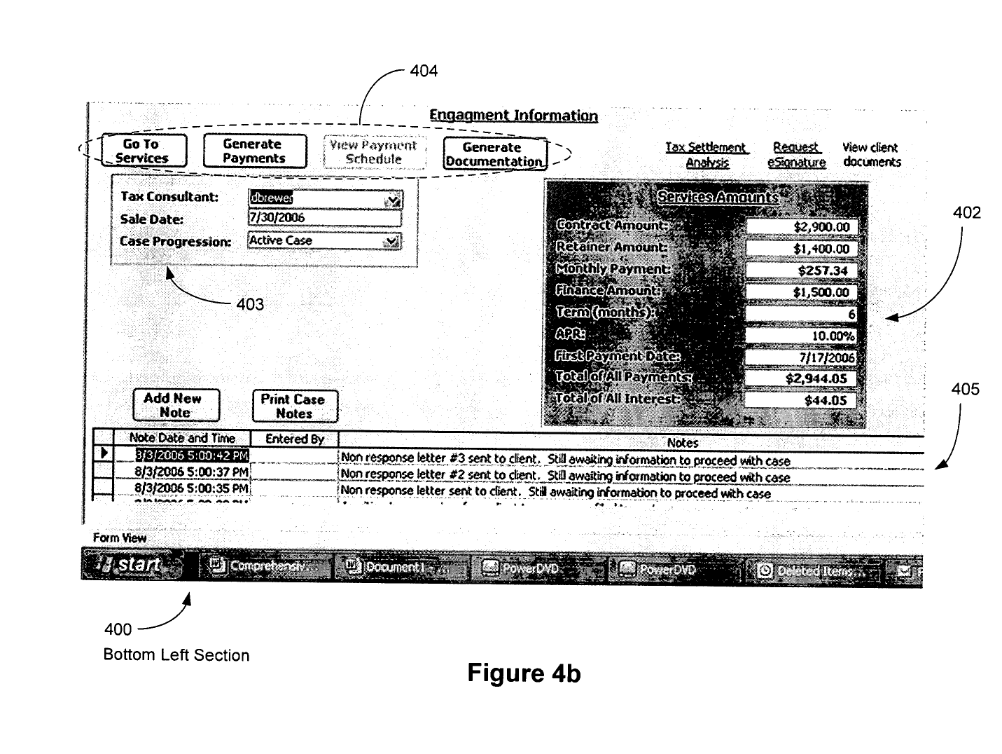

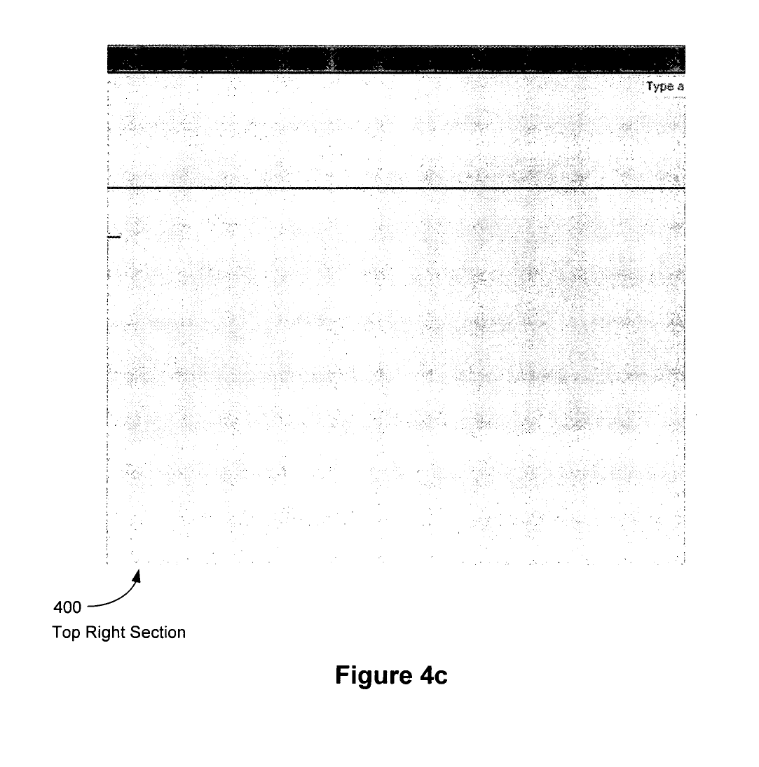

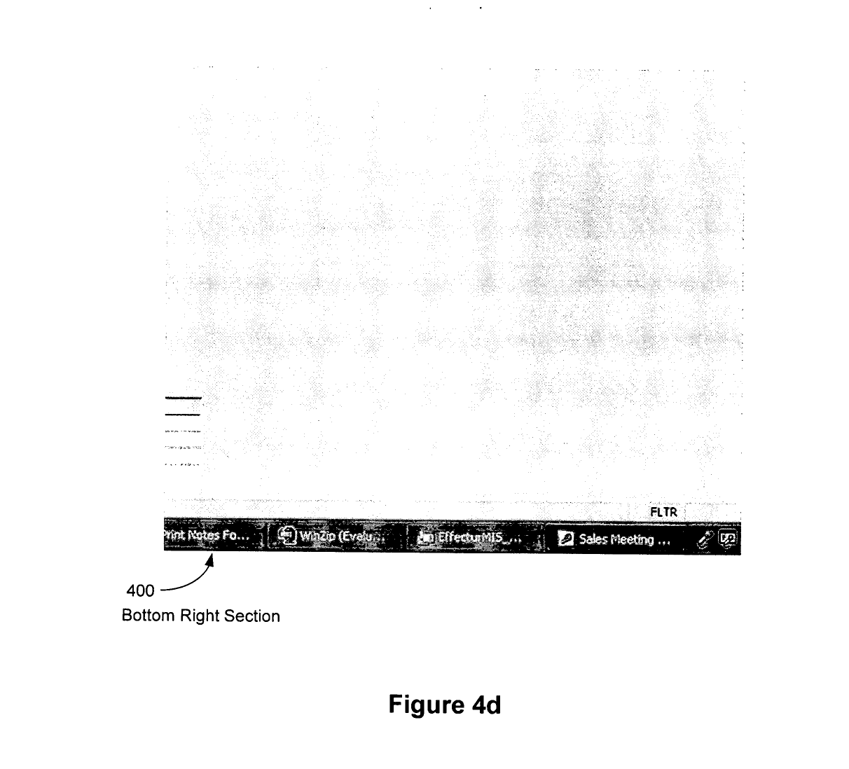

FIGS. 3 and 4 illustrate snapshots of an example graphical user interface for the client 101 (FIG. 1) to interact with sales module 102. Snapshot 300 of FIG. 3 illustrates a service selection and pricing screen of the user interface which shows the services that the company can supply to a client 101 and prices associated with these services. If one or more desired service is selected through selection tool 301, the price of each of the services may be displayed (302) and a total of the prices (303) may be generated by clicking on a “calculate totals” (304) or automatically generated. The interface may be web based so that a client can enter the desired services on the screen. Alternatively, the business may have access to the screen and be able to enter the desired services when a communication is made between a potential client and the business. For example, a potential client may call the tax preparer on the phone indicating that he wishes for the tax preparer to prepare an individual tax return, and submit a state installment agreement. The employee at the tax preparation service would use the mouse to check the boxes corresponding to individual representation fee, prepare individual tax return, and submit state installment agreement (see FIG. 3). In this example, a total of $2,900 is generated for the tax preparation business.

In one embodiment, the interface internal to the company that allows a worker or salesperson to assist a client/potential client in selecting services includes additional information not visible to the client, including, but not limited to, the company's cost for each selected service and a manual input of price quoted to the client for the selected service. Thus, the sales module 102 calculates the profit margin each service (price quoted—company's cost for service) and the total profit margin (total of the service profit margins). Therefore, the system 100 collects information as to profitability of each service and/or client. The information is also organized per worker or salesperson in order for the company to determine a worker's profitability and value to the company.

When submitting statements to the IRS, the IRS requires proof to substantiate statements. Therefore, the IRS requires copious amounts of documentation to substantiate all statements submitted to the IRS on behalf of the client. For example, a client who wishes to substantiate a statement of how much is in a bank account per month may need to submit to the IRS three months worth of bank statements. In another example, a tax return requires the submission of W-2's from all employers during the year. In one embodiment, in order for the company to determine if all documentation has been received from the client, the sales module 102 creates a client documentation list for each engagement. Each engagement may include a series of selected services to complete. Each service includes one or more tasks that represent a specific portion of the amount of work for each service. Each task may have a known list of client documents that will be submitted to the IRS. Thus, when an engagement request is accepted by the system 100 and includes the requested services, the sales module 102 populates a list of required client documents from the tasks of the selected services in the engagement. In one embodiment, a checklist of required client documents is included for each engagement. The client is notified of which documents are required and thus submits them to the company (e.g., sending a W-2 via electronically or mail). When a document for a specific engagement is received, the document is scanned or converted into an image and associated with the engagement. The image is then forwarded to a case specialist for the engagement. Upon review of the image, the case specialist selects which document is received. If the document is insufficient or incomplete (e.g., page 3 of a five page document is missing), the case specialist notes such deficiency so that the system 100 may mark the document on the checklist “received but insufficient.” The system 100 then automatically generates from the document list and sends recurring updates and reminders to the client as to which documents are received and complete and which documents are outstanding or received but insufficient. The updates may be in the form of email, automated telephone call, SMS, text message, or displayed on a client interface screen in a web portal (later described).

Referring back to FIG. 2, the sales module 102 (FIG. 1) creates and sends an engagement letter to the client 101 upon receiving the engagement request. Snapshot 400 of FIG. 4 illustrates a sales meeting screen of an example client interface for sending an engagement letter from the sales module 102 to the client 101. The example engagement letter generally includes: various personal and business information 401 about the client; services amounts 402; the worker(s) assigned to handle at least portions of the case (403); various engagement information tools 404 to create, e.g., payment amounts and dates for services, records in a printable format, and navigation options for the various client selected services; and transactional history 405 of the case. In one embodiment, any information previously entered by the client 101 is filled into the sales meeting screen by the sales module 102 before sending the information to the client 101. For example, the total amount in price 303 in FIG. 3 is transferred to the service amount section 402 of screen 400 in FIG. 4. In another embodiment, client information from prior services is stored in a database for retrieval. Therefore, personal and/or business information is retrieved by the system 100 for previous clients in order to fill in section 401 of the screen. Furthermore, any information not yet retrieved from storage or received from the client is requested at the time the information in FIG. 4 is sent to the client from the sales module 102. In another embodiment of the present invention, the sales module also sends a request to the client for payment information listed in 402 for services performed and/or to be performed. In one embodiment, payment authorization may be in writing or by verbal permission when talking to a worker or salesperson of the company. The client may also give permission to setup automatic recurring credit card or bank account payments.

Referring back to FIG. 2, the sales module 102 receives a signed engagement letter from the client 101. In one embodiment, when a sale is made (engagement letter signed) the client pays an initial retainer and then signs a promissory note, which may also be generated by the interface/application. The application may also calculate an amortization schedule for payment amounts and may optionally write payment amounts and due dates to a payment table for the unpaid balance of fees associated with the engagement (e.g., as shown by 402 of Snapshot 400 of FIG. 4). The engagement may then be accepted into the case management group as a case. A signature may be a digital signature, an acceptance of the company's rules and policies in servicing the client, and/or submission of permission to bill the client for services rendered or to be rendered. The signed engagement letter and service and payment terms are forwarded to the operations module 103 (FIG. 1), wherein the operations module 103 divides the services listed in the engagement letter into specified categories and assigns the tasks of each category to a specialist for that category. In an alternate embodiment, the case is assigned to one of a plurality of symmetrical practice groups.

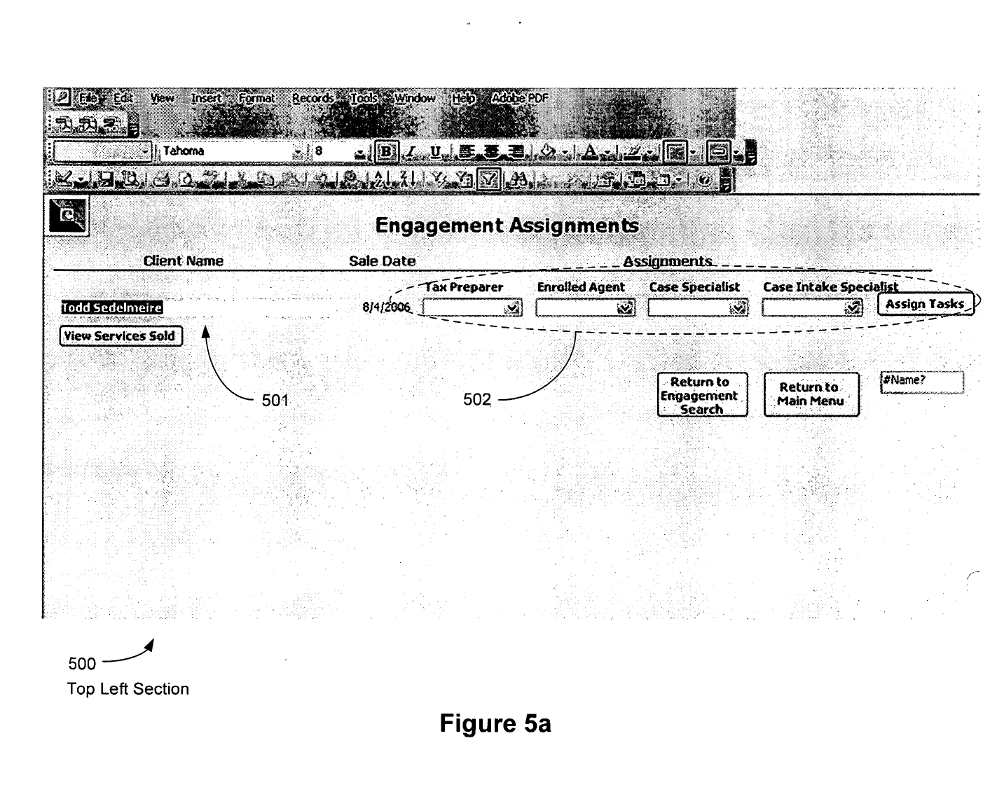

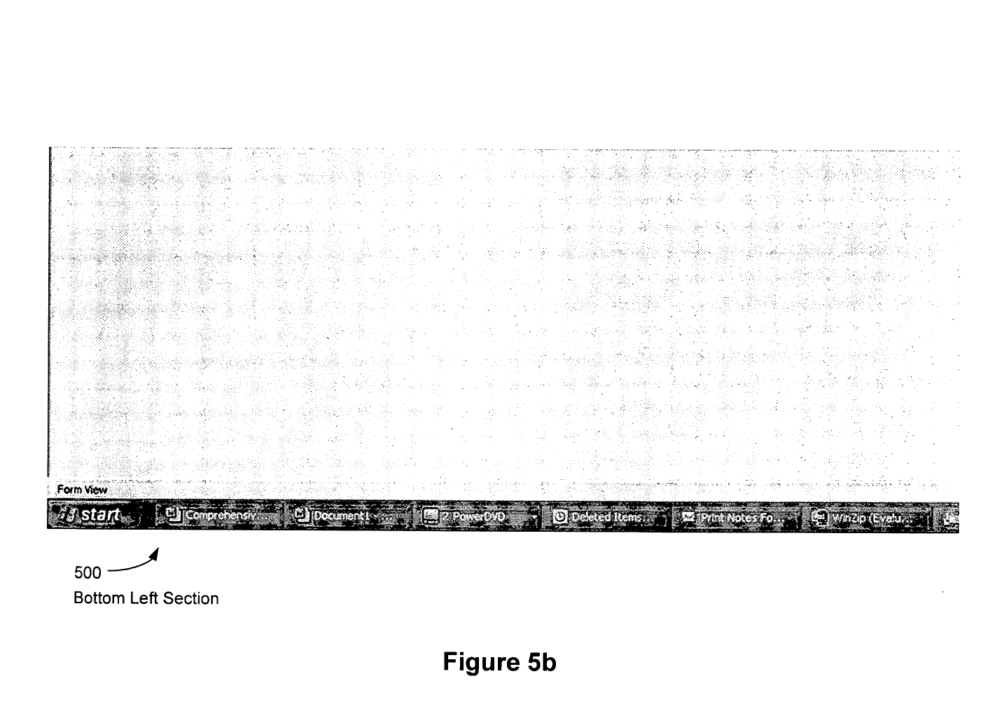

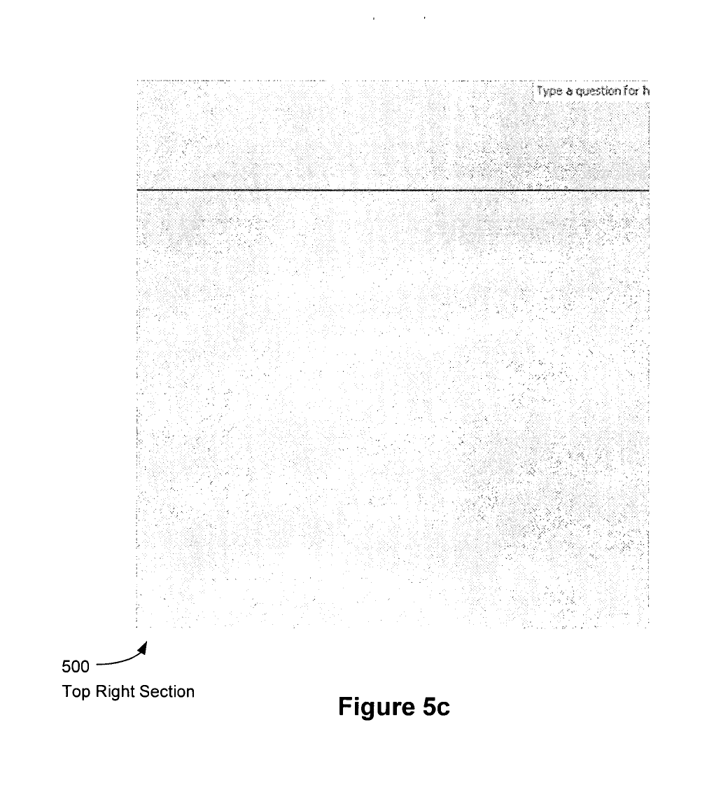

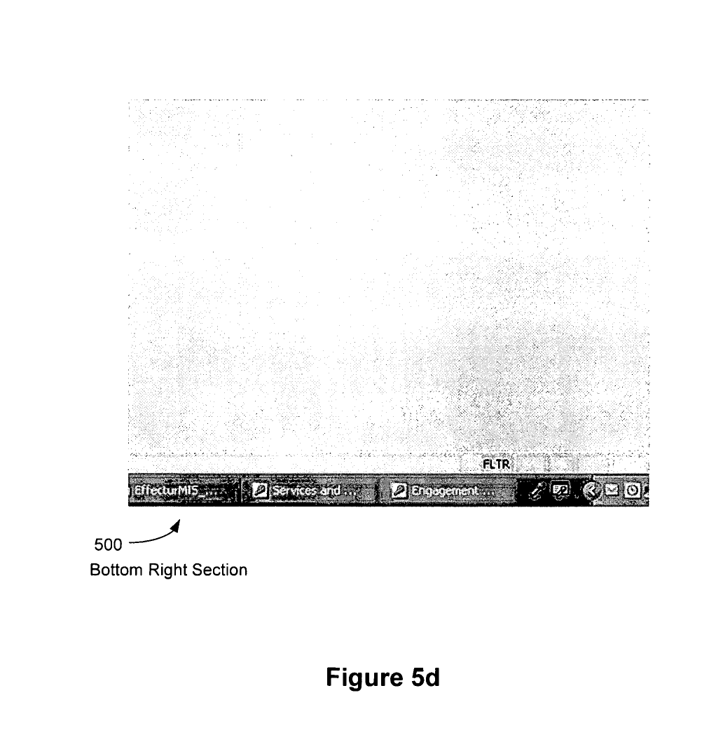

In one embodiment, at least four categories of specialization exist: a licensed professional representative (assisted by module 104 of FIG. 1), a case specialist (assisted by module 105 of FIG. 1), a tax return preparer (assisted by module 106 of FIG. 1), and a case intake specialist (assisted by module 107 of FIG. 1). Therefore, in one example, the “prepare individual tax return” service as shown selected in snapshot 300 of FIG. 3 is divided from the other services and assigned to a tax return preparer. FIG. 5 illustrates a snapshot 500 of an engagement assignment screen of an example interface for dividing and assigning tasks by the operations module 103 of the system 100 of FIG. 1. In one embodiment, the operations module 103 automatically divides and assigns work based on factors such as specialist workload, time sensitivity of project, client preference, etc. Therefore, snapshot 500 of the interface, if completed by the operations module 103, would show the client name or some other case identifier (503) and the specialist(s) assigned to each category (502). In another embodiment, the interface allows the operations module 103 to request assignment of specialist(s) for a particular case from a worker. Thus, someone within the company would assign a specialist from each category for each case. The operations module 103 then assigns the appropriate services to the specified individuals.

In one embodiment, engagement assignments are access restricted so that only the specialist working for that particular client has access to the engagement assignments. Alternatively, the engagement assignments are access restricted so that only a desired population of people can view the engagement assignments. Each service to be performed within each engagement may have a number of tasks associated with it, each to be carried out by a different specialist type on the practice team. For each task in one embodiment, the task has one, more, or all of the following elements that define the task and parameters of the task necessary for completion of the task: task name; sequence number within the service; duration (time required to complete the task); owner (the specialist type); date on which the task is assigned to its owner (Assign Date); projected completion date calculated based on Assign Date and Duration; actual completion date; pre-defined case history note; percentage of the effort required to complete the service that is associated with the task; and number of times the task has been reset.

Once services are assigned to the required specialists in 204 of FIG. 2, the outstanding tasks for each specialist affected by the new case are prioritized so as to reflect the addition of services to each affected specialist's workload in 205. For example, the workload of a tax return preparer who is assigned a new tax return service is prioritized and includes the new tax return service. In one embodiment, the operations module 103 prioritizes the workloads before sending the prioritized new tasks to assistance modules 104-107 (FIG. 1). In another embodiment, the operations module 103 sends the services before prioritization to the assistance modules 104-107 wherein the modules 104-107 prioritize the workload for specialists. The system 100, whether by the operations module 103 or assistance modules 104-107, also calculates a projected completion date for each service or task to be completed. The projected completion date is automatically determined through observation of multiple factors related to the specific task or service. For example, the projected date of completion depends on factors including, but not limited to, the complexity of the service or task, the required completion date of the service or task, the workload of the assigned specialist, the priority of the service or task in relation to other outstanding services or tasks.

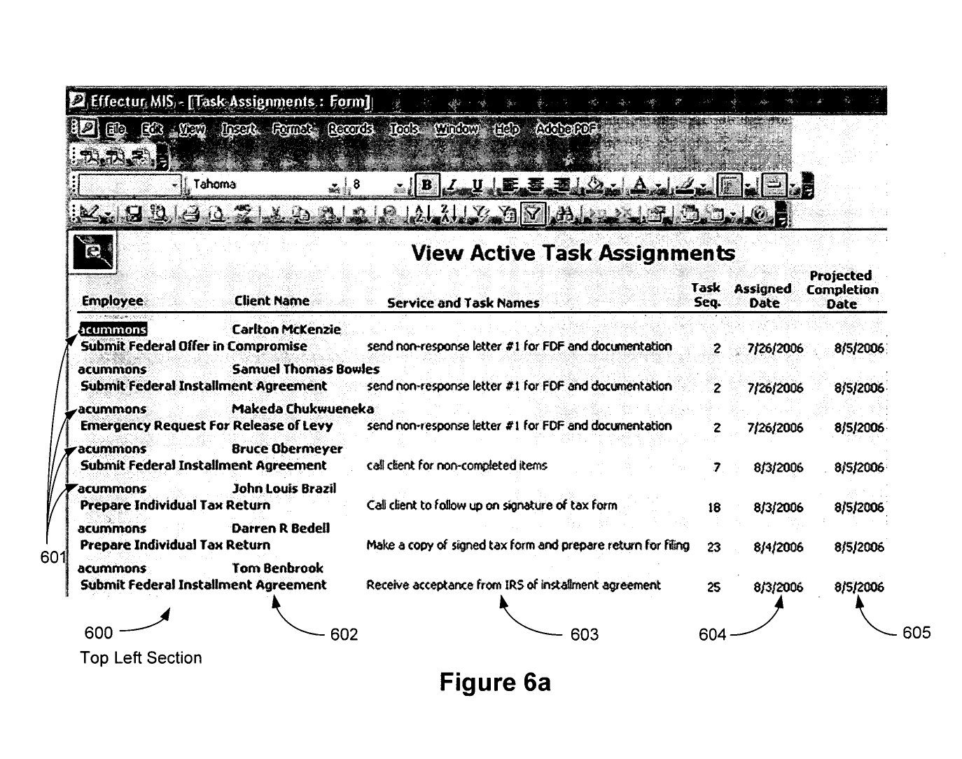

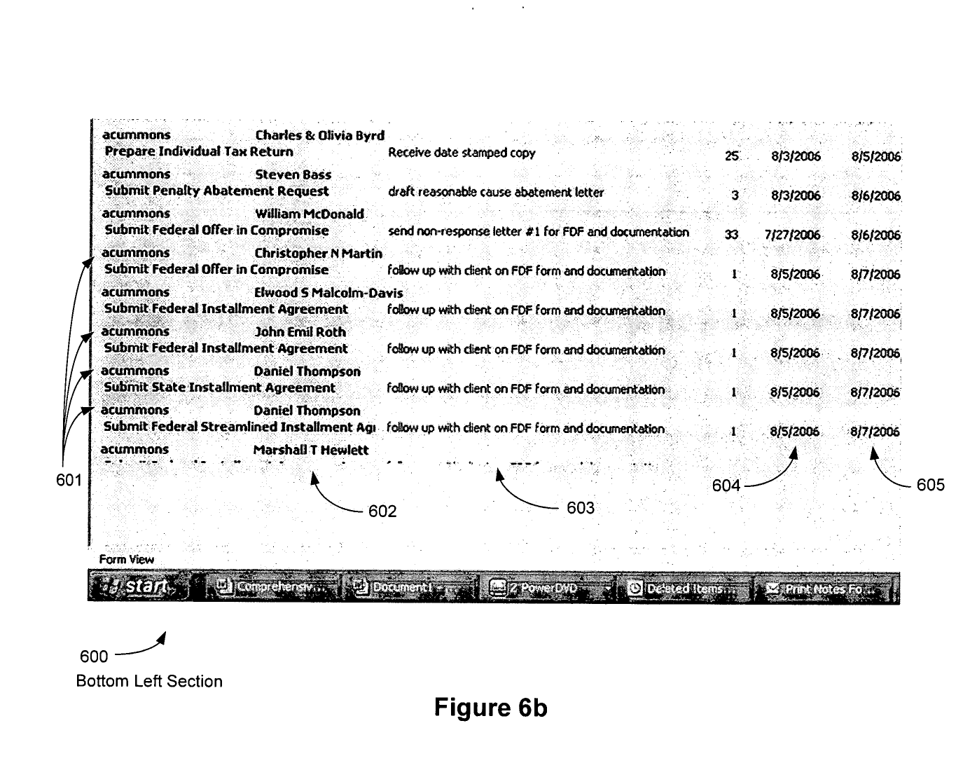

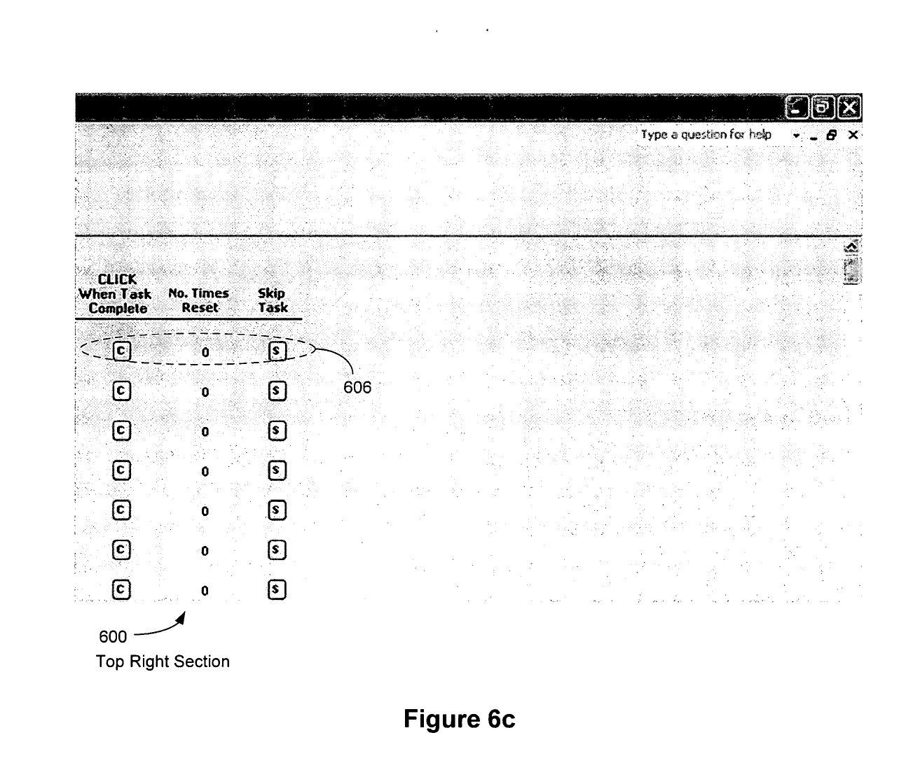

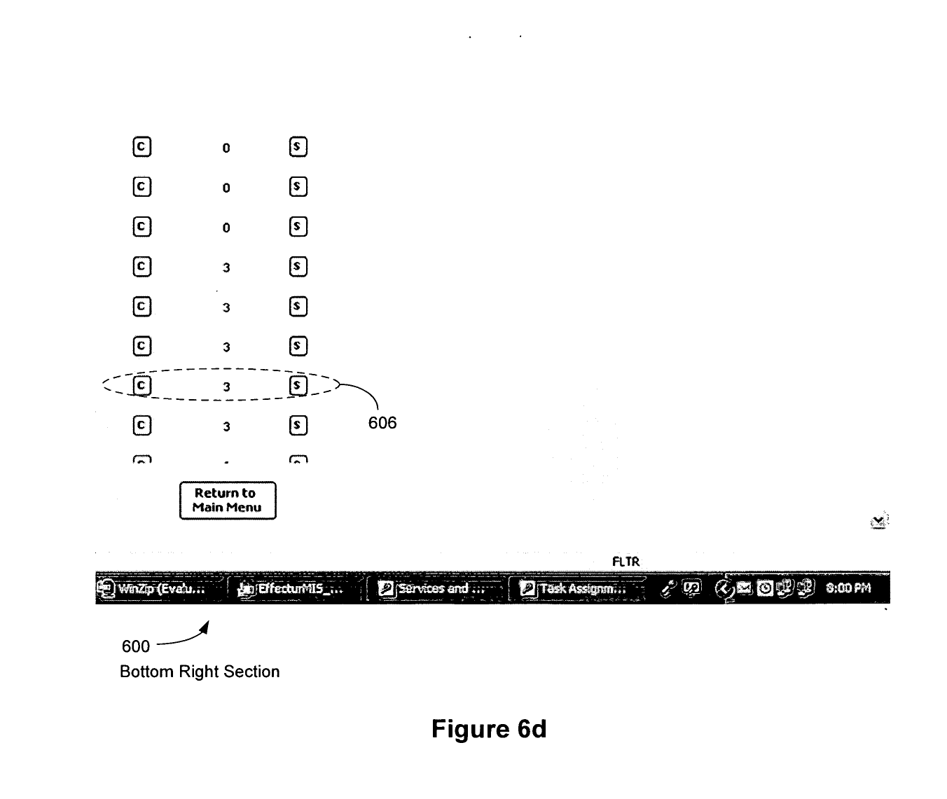

FIG. 6 illustrates a snapshot 600 of a task management screen of an example interface for the system of FIG. 1 to manage workload and assist in the completion of tasks by specialists/workers. The screen may show workload before or after prioritization. The task management screen lists outstanding services or tasks to be performed by an owner. For each owner 601, the task management screen generally includes for each listed outstanding service: client name or other case identifier 602; a description of the service or task to be performed 603; an assignment date 604 when the specialist became owner of the service or task; the projected completion date of the service or task 605; and inputs 606 to allow a specialist to input whether a task has been completed, skipped, and the number of times the task has been reset for processing. In one embodiment, the listing of tasks to be performed are in prioritized order such that the top task is the task to currently be performed by the owner. In one embodiment, tasks are dynamically prioritized for each member of the practice group according to the projected completion date from earliest to latest across all clients, engagements and services. A practice group member is thus able to carry a large number of cases in their working inventory and never waste time ascertaining the highest priority task to be completed. This system also ensures that no client is ever forgotten or deadline missed.

In another embodiment, the operations module 103 or assistance modules 104-107 may prioritize tasks or services based on refund risk of a client or engagement. A refund risk is a client or an engagement for a client where the company runs the risk of giving a refund back to the client. A refund risk exists if the amount of fees a client has paid is greater than the amount of fees earned for an engagement. For example, if a client has paid $80 and the company has earned $50, the refund risk is $30. If the client were to cancel the engagement at that point, the company would refund the client $30. The amount of fees earned is determined by tasks completed for an engagement. As previously stated, each task represents a percentage of the work to complete a service. A service has a specific fee associated during the engagement request to/from the sales module 102. Therefore, a task is assigned a monetary value equal to the price of the service times the completion percentage of the service the task represents. For example, if a service is priced at $200 and a task is 50% of the work to complete the service, the task is valued at $100. Conversely, a negative refund risk is a collections risk. The company risks receiving payment for money earned but not yet collected from the client. Collections risk equals the amount earned for an engagement minus the amount of fees received from the client.

Therefore, engagements may be prioritized by refund risk in decrementing order (highest priority is the greatest refund risk) with collections risks being at the end of the prioritized list. Tasks are then prioritized to determine which tasks most efficiently lower the refund risk. For example, tasks from engagements with higher refund risks are higher priority than tasks from engagements with collections risk or minimal refund risk. Tasks of more value within an engagement with higher refund risks are then higher priority than tasks of lower value from the engagement. Prioritization may further include amount of time required to complete each task.

The completion of a task deactivates the task and activates the next task in the sequence for that service with an assign date and an owner (it may be the same owner or another member of the practice group) as well as a projected completion date when the specialist selects that a task has been completed or skipped (606). The application also writes the pre-defined case note to the client's case history with a date and time stamp as well as the identity of the person who completed the task. This chain of task completions continues until the end of the sequence at which time the service has been rendered and the fee earned.

Upon the tasks being prioritized and sent to the correct assistance modules 104-107 for the specific task, the assistance modules 104-107 assist the specialist(s) in completing the tasks within the specialist(s) prioritized list of outstanding tasks. In one embodiment, each of the assistance modules 104-107 routinely notify the corresponding specialist of upcoming deadlines, alarm the specialist of imminent deadlines, and automatically report any deadlines missed to group manager module 108. For example, the tax return preparer module 106 will notify a tax return specialist weekly of outstanding tasks and notify the tax return specialist everyday when a tax return is still outstanding within seven days of its completion deadline. In addition, the assistance modules 104-107 automate processes to relieve redundant manual entry by the specialists. For example, the tax return preparer module 106 will download any electronic W2 withholding statements from the IRS and fill in any tax information from the documents into federal and state returns requested by the client. The assistance modules 206 assist in the completion of a task until the task is completed, the deadline passes for the task to be completed, or it is determined (e.g., by the corresponding specialist) that the task cannot be completed without further review (e.g., missing documentation).

If a task expires (that is, its projected completion date is earlier than the current server date, or alternatively, the projected completion date of the task has passed without being completed) or a task is deemed by the specialist to need further review (207 of FIG. 2), the task is sent from the residing assistance module 104-107 to the group manager module 108 (208). If all tasks are completed, then the processes exits at 210. In one embodiment of a task needing further processing, the task disappears from the specialist's view and appears on a manager's view to be reset (as shown generically in FIG. 1). This alerts a manager that a deadline has slipped and that remedial action should be taken. The manager may alternatively be alerted that information is required from the client in order to complete processing of the task. In addition, the client may be alerted as to a missed deadline or that a task requires further information and for the client to contact the company. The tasks are then reset and reassigned to the same or a different specialist for completion in 209. Process then flows back to 206, wherein the tasks are sent to the correct assistance module 104-107 to be completed. The process of 206-209 is repeated until all tasks are completed or terminated. In one embodiment, multiple iterations of the method illustrated in FIG. 2 are performed in parallel by the system 100 (FIG. 1).

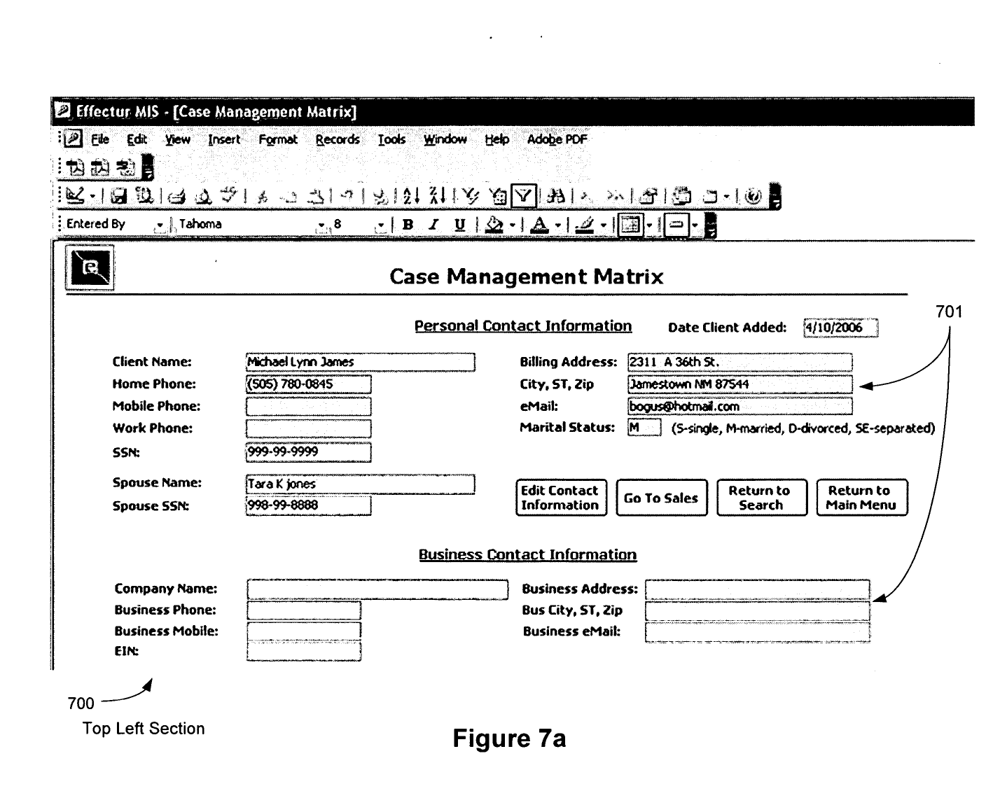

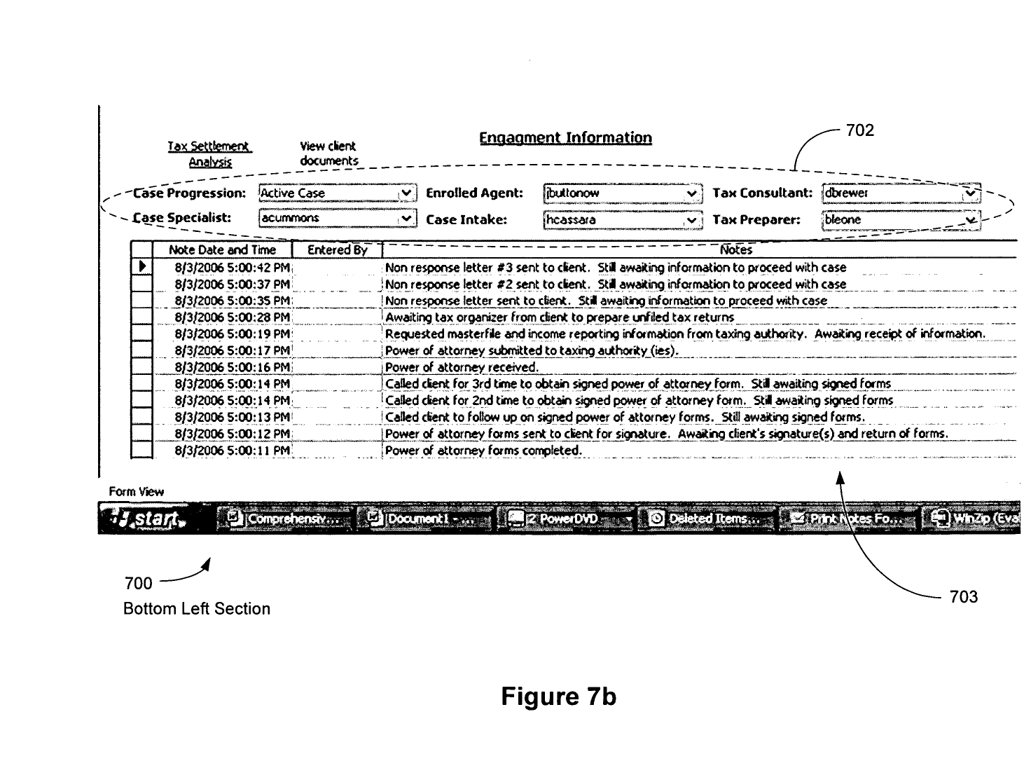

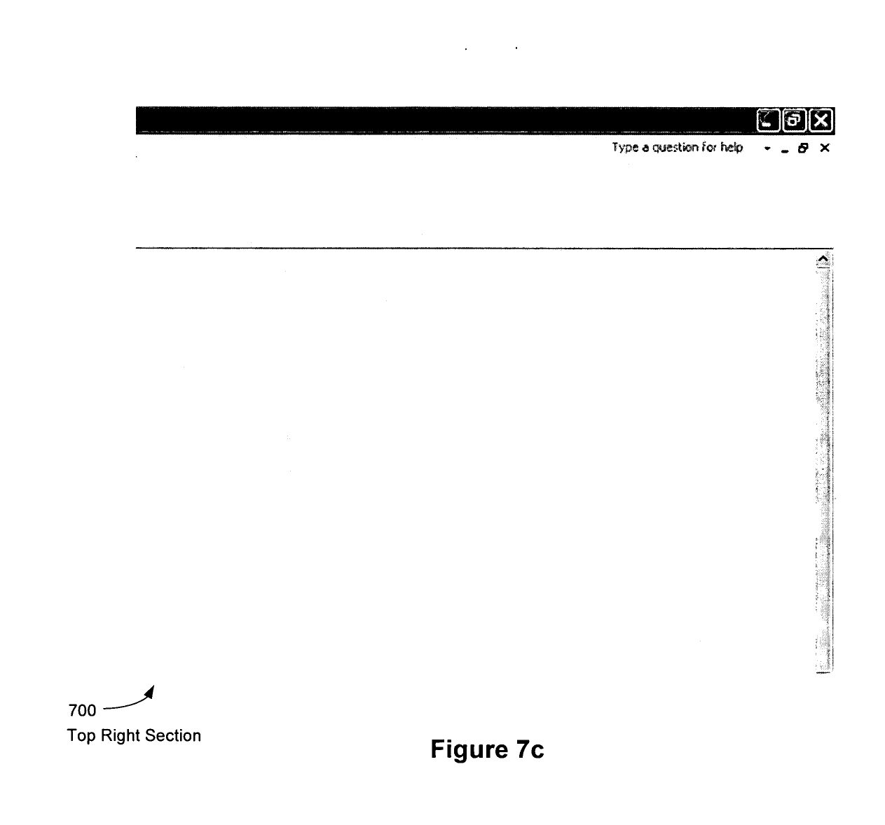

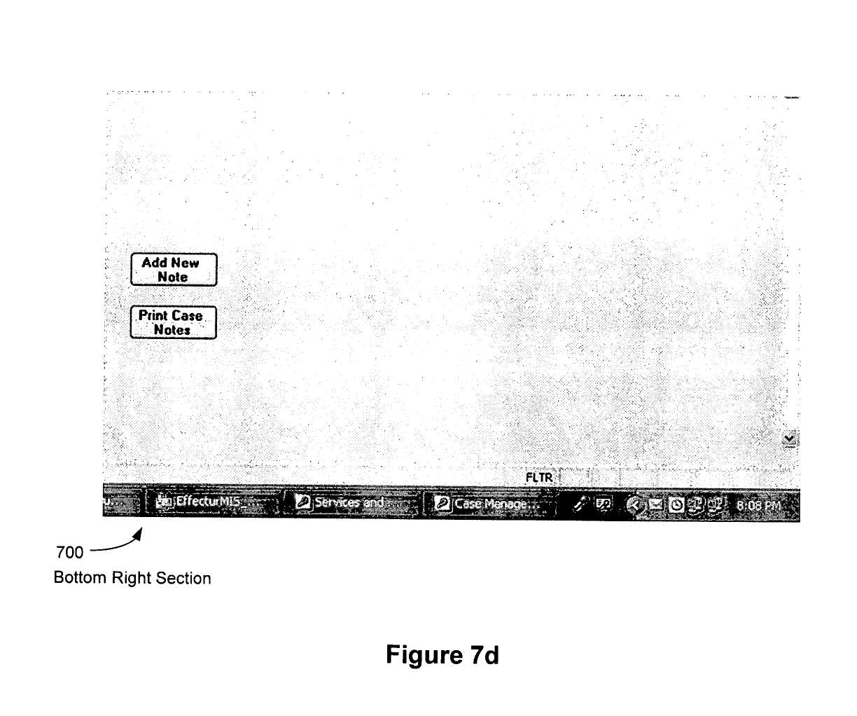

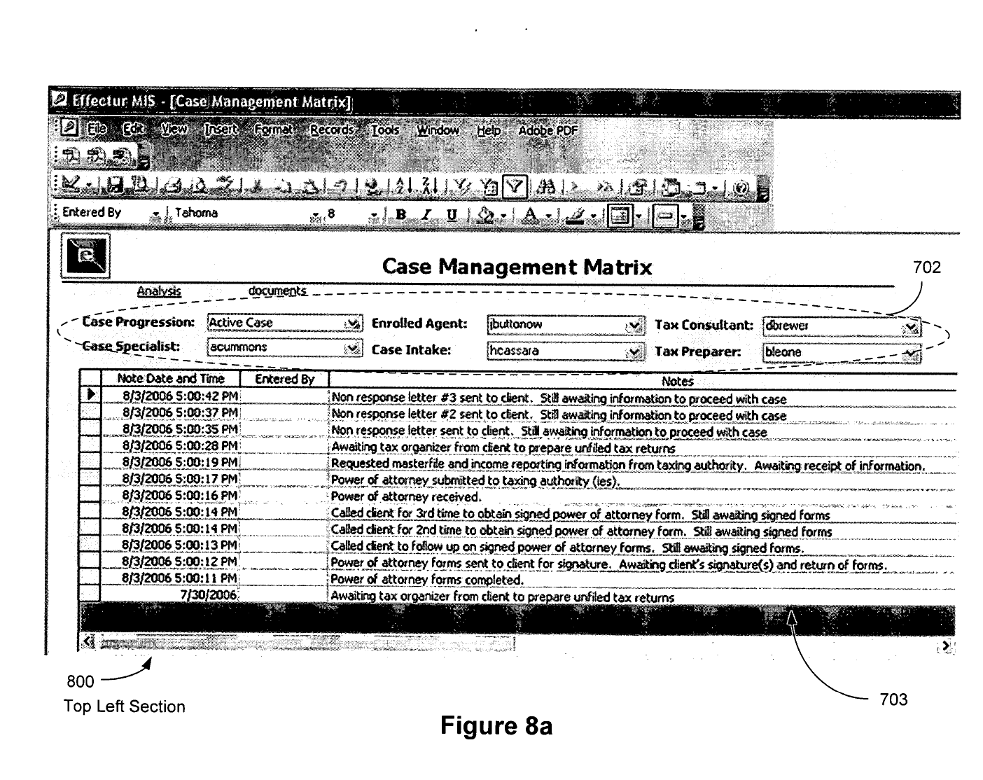

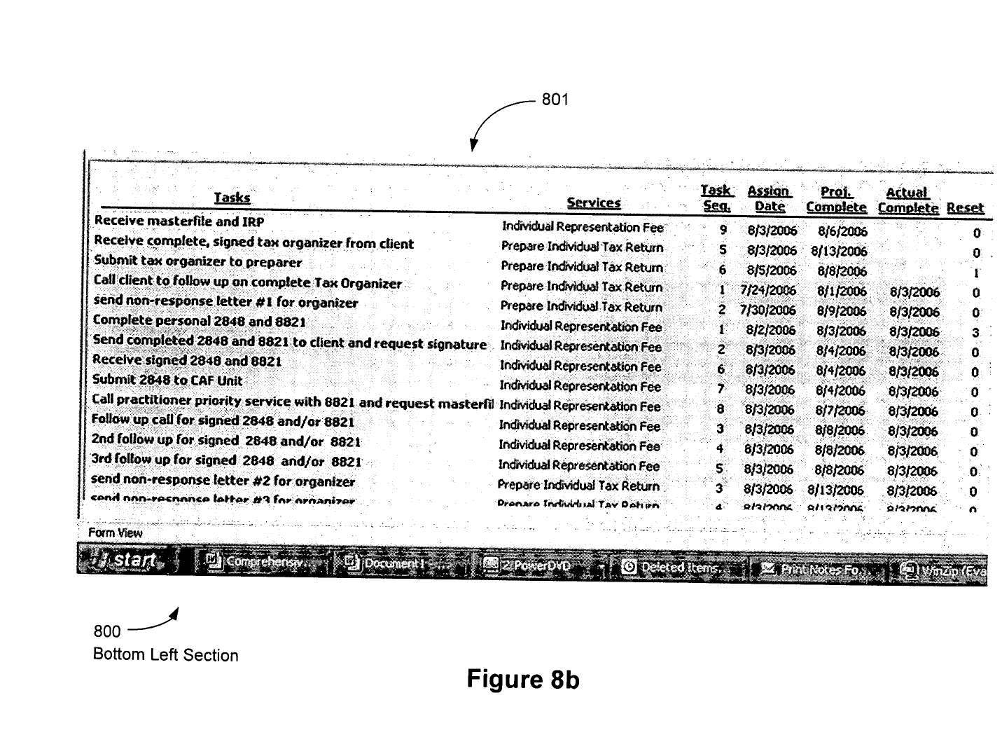

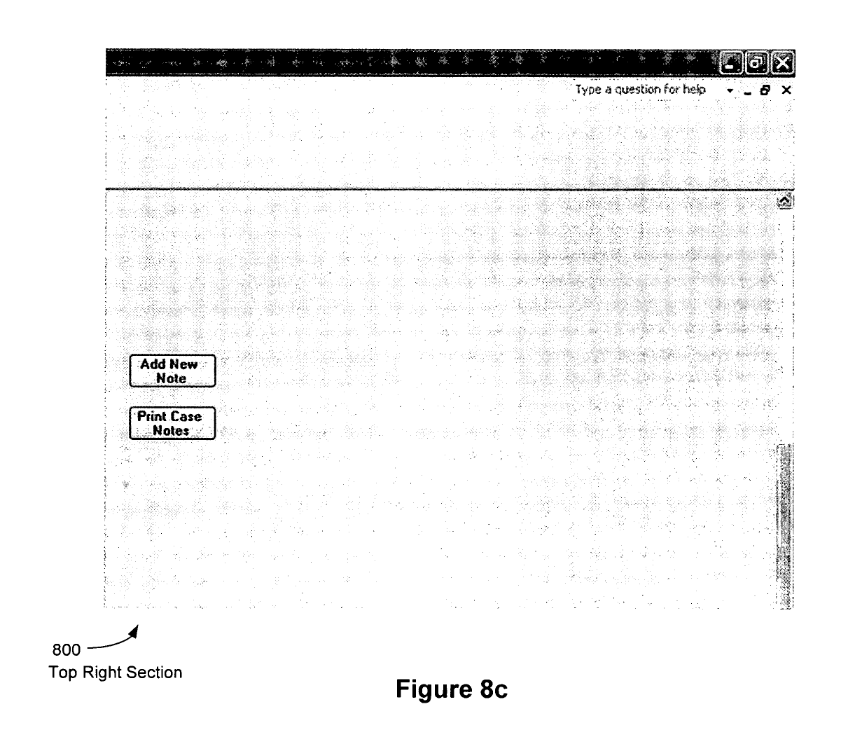

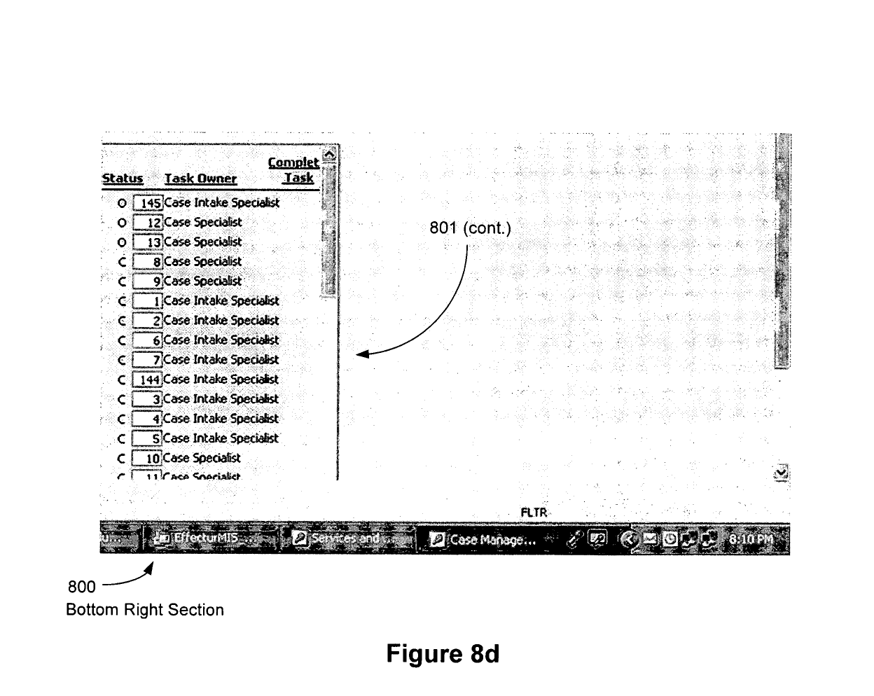

In one embodiment, in addition to allowing all tasks across all clients to be managed and viewed by any given number of employees, a service or task and its progress and/or transactional history within the company may also be viewed at the client level for multiple engagements from the client case management view below. Varying degrees of desired amounts of information are determined by the company to be made available to workers or specialists. Snapshot 700 in FIG. 7 and snapshot 800 in FIG. 8 illustrate a case management screen for a worker interface so as to update the worker as to current progress on any outstanding engagements or services. The example worker interface illustrated in snapshot 700 (FIG. 7) includes: personal information 701 which allows the worker to update any erroneous or outdated information still held by the company; engagement information 702 to inform the worker which specialists are assigned to each portion of a task, service, or engagement; and transaction history 703 to inform the worker of all activity occurred on the task, service, or engagement. The example worker interface illustrated in snapshot 800 (FIG. 8) includes: engagement information 702; transaction history 703; and a list of tasks 801 with various information including outstanding status or completion date, category of task, task owner, assignment date, task name, and number of times task is reset. The screens illustrated in FIGS. 7 and 8 may be used in conjunction with or alternative to each other.

In one embodiment, a task manager interface also exists for the client. The interface may be similar to snapshots 700 and 800 (FIGS. 7 and 8), but the company is able to decide which information is accessible by the client. In one embodiment, a client interface exists through a client web portal wherein the client 101, through the web or other access means, interfaces the group manager module 108 of FIG. 1. The screen of the interface displays transaction history 703, amount of fees collected, amount of fees outstanding, and percentage completion of each service of engagement. As previously stated, each task represents a specific portion of work of a service. For example, task 1 may represent 20% of the work to complete a service. Therefore, the number of tasks completed and the number of tasks yet to complete for a service are used by the group manager module 108 to calculate the percentage completion of each service of an engagement. The module 108 determines completion of a task or a task is outstanding by receiving notice from a specialist that a task is complete or review of a specialist's workload that a task is outstanding. Once the group manager module 108 calculates the percentage completion of each service of an engagement, the group manager module 108 graphically displays the percentage completion(s) to the client via the web portal interface screen (e.g., a bar graph or a pie chart). Hence, the client is updated as to the status of his or her case without contacting a worker or specialist at the company and therefore absorbing company resources in an inefficient manner.

In one embodiment, an automated client payment processing application or module is integrated into the web portal and the group manager module 108 (FIG. 1). As previously stated, a client may initially give authorization to the company to automatically bill the client's bank account or credit card periodically over a period of time. The client interface of the web portal allows the client to make any necessary changes to billing information so as to prevent any disruptions of cashflow to the company.

As previously stated, a client may be notified of outstanding documents from the client documentation list for a specific engagement on the client interface screen of the web portal. Therefore, in one embodiment, the client interface includes a section to inform the client which documents are being collected and portion of those have yet to be received or were received but are insufficient. The client interface screen may also include information as to date of receipt of each document, date submitted to IRS, and date document was reviewed and accepted or rejected by the case specialist.

In addition to the above features of the system 100 or an application of the system, the application/system has user-level security and access to functionality that is controlled by each worker or specialist. In one embodiment, each worker/specialist is able to view, complete, and skip only tasks that are assigned to them as owner. Furthermore, the system 100 or an application on the system generates reports based on information for the multitude of tasks completed. In one embodiment, the reports provide by employee, by group or at the company level the total amount of revenue earned for a given period of time, which may be used as the basis for a production-based compensation system for the case management team and as a basis for revenue recognition for individual teams or employees. Management is also able to see from the report(s) the average actual time it takes to complete certain tasks and which tasks are reset most often in order to modify case assignment and maximum workloads per specialist or worker.

### Automatic Settlement Payment Determination

One client service of particular importance is the determination of IRS tax settlements and payment structures. In one embodiment of the present invention, system 100 (FIG. 1) automatically determines a tax settlement payment option based on a variety of information provided to the system 100.

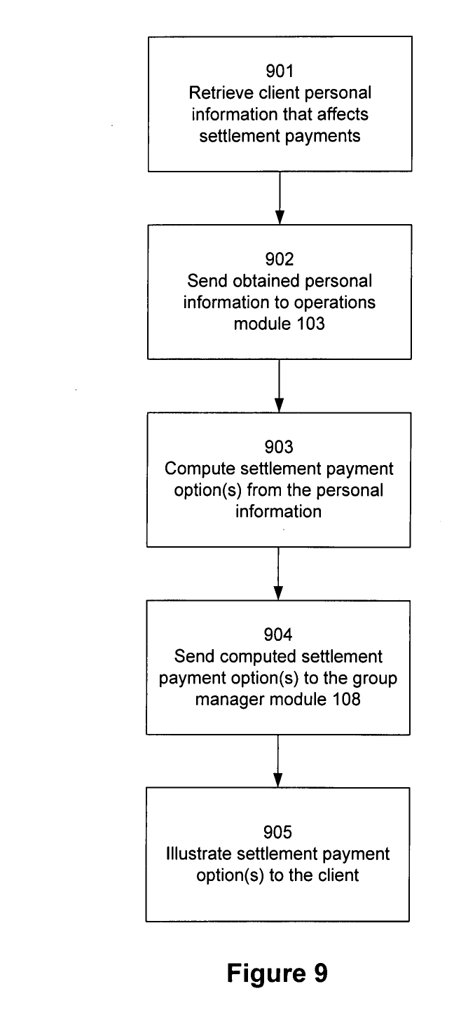

FIG. 9 illustrates an example method of system 100 (FIG. 1) determining a tax settlement payment schedule and structure for a client. Beginning in 901, the sales module 102 retrieves personal information of the client 101 that may affect settlement payment options, amount, and schedule. In one embodiment, the client 101 is asked for the information. In another embodiment, the information is obtained from signed engagement letter, stored information previously input by the client, information stored on the IRS database, or information input by a worker of the company. The information may include, but is not limited to, number in family, county of residence, US geographic region of residence (southeast, northwest etc.), and number of automobiles necessary to earn the family income. Further data that may affect a client's settlement options include, but are not limited to, amount owed to IRS, settlement amount between IRS and client, value of real property, lien values on real property, quick sale values of real property, classification of properties as primary residence, values and liquidation values of bank accounts and investment accounts (e.g., 401(k) and IRA), and liquidation values of insurance policies and required payments. Supplemental information may also be obtained, which may include, but is not limited to, names of persons in household, date of births, Social Security Numbers, contact information, and name of bank where an account is held.

Upon the sales module 102 receiving all of the personal information, the information is sent to the operations module 103 (902 of FIG. 9). A settlement payment option or a variety of payment options are then computed from the personal information by the system 100 (903 of FIG. 9). In one embodiment, the operations module 103 computes the payment option(s) and tags the service as completed through automation. In another embodiment, the operations module 103 assigns the service/task to one of the assistance modules 104-107. The assigned assistance module (e.g., case specialist module 105) then automatically computes settlement payment option(s).

In one embodiment of computing a settlement payment option, settlement calculations and recommendations for settlement payment options are based on the sum of: (1) the taxpayer's net equity in assets; and (2) the taxpayer's ability to make monthly payments/future income potential. The IRS publishes guidelines on how to compute the net equity in assets of a taxpayer. The IRS guidelines are preentered into the system 100 in the form of an algorithm so that the system 100 may compute the net equity in assets of a taxpayer. In addition, any computations previously done by hand may be preentered into the system 100 so that the system 100 may automatically compute the necessary processes. IRS guidelines define the net equity in assets of a taxpayer as the quick sale value minus total encumbrances for each of the following assets: primary residence (of the taxpayer); other real property; automobiles owned by the taxpayer; checking accounts; savings accounts; qualified retirement accounts (e.g., IRA or 401(k)); other investments (e.g., stocks, bonds, annuities); cash value of insurance; and any other assets specified by the IRS. Therefore, the system 100 (e.g., the operations module 103 or the case specialist module 105) automatically calculates the net equity of each asset and totals them together to determine the net equity in assets of the client.

The taxpayer's ability to make monthly payments/future income potential is based on the gross monthly income of the taxpayer minus taxes and allowable living expenses. The allowable living expenses are traditionally calculated using national living standards or the amount of actual expense for each category, whichever is lower. In one embodiment, the national living standards are preentered into tables stored on the system 100 for each living category as defined by IRS guidelines. Thus, the system 100 computes allowable living expenses by totaling for each category the amount of actual expense or the national standard for each category, whichever is lower. The system 100 uses a table lookup to determine the national standard for each category. In one embodiment, the tables are indexed by the personal information obtained by the system 100 in 901 of FIG. 9. Living standard calculations are calculated for the following categories as shown in the below table and looked up from a table published by the IRS based on data collected from the user or populated by a worker onto the system:

| Expense Category | Looked up based on |
|---|---|
| 1. Food, Clothing, and | Number in family and gross income for |
| Miscellaneous | household |
| 2. Housing and utilities | County of residence and number in family |
| 3. Auto Maintenance/ | Number of automobiles and region of the |
| Public Transportation | country |
| 4. Auto payment One | A set allowable amount |
| 5. Auto payment Two | A set allowable amount |

The system 100 or the application on system 100 uses income input from the client for both spouses in a household according to pay stubs or other income documents and converts the amounts to monthly amounts according to the frequency of pay input by the client. For example, a pay stub amount is doubled to equal the monthly amount if the client is paid twice a week. Taxes and other payroll deductions are also input by the user from pay stubs and prior year's tax returns are converted to monthly amounts according to the pay frequency input by the client.

Since expenses may be determined by actual living expenses, the application or system 100 obtains from the client actual amounts for items in each of the living expense categories. The application or system 100 allows for actual amounts unless there is a national living standard associated with the expense category, in which case the application or system 100 selects the appropriate standard value from a lookup table and compares the standard amount to the actual amount and populates the living standard calculation category with the lower of the two amounts.

Once each expense category has been correctly calculated, the system 100 or application totals and subtracts allowable living expenses from the difference of monthly gross income and taxes paid (i.e., monthly gross income—taxes paid—total allowable living expenses). This calculation gives the taxpayer's ability to make monthly payments, which is used by the application or system 100 to calculate estimated installment payments for a negotiated installment agreement with the IRS. This calculation product is also used to calculate the future income potential for the submission of an offer in compromise.

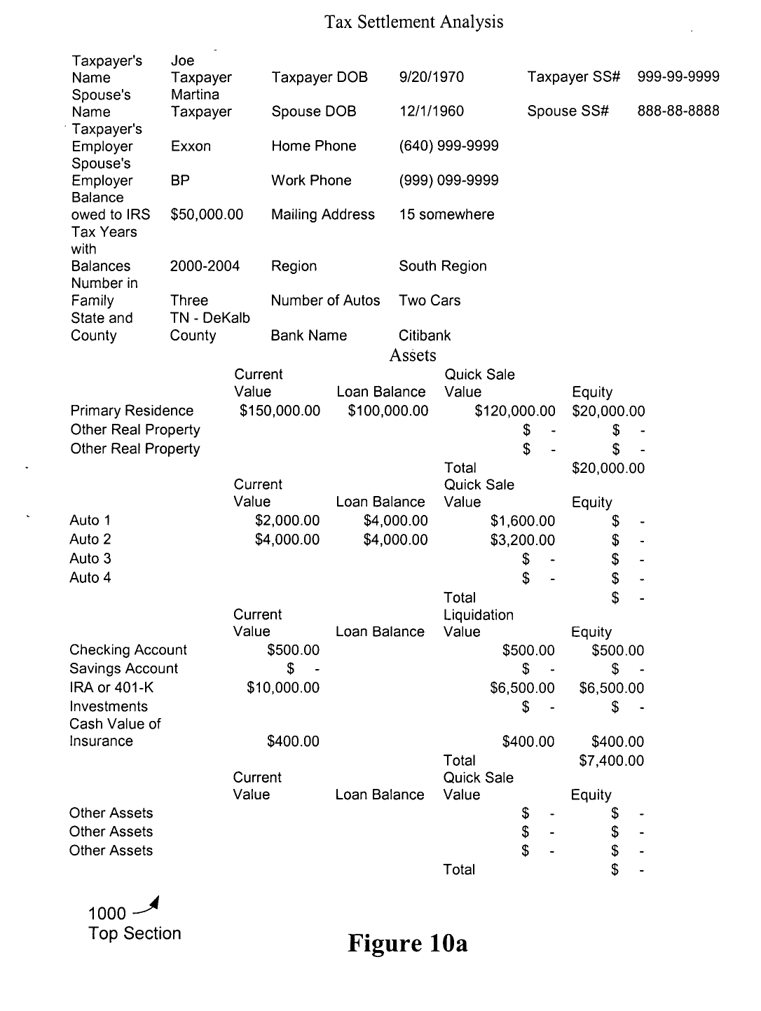

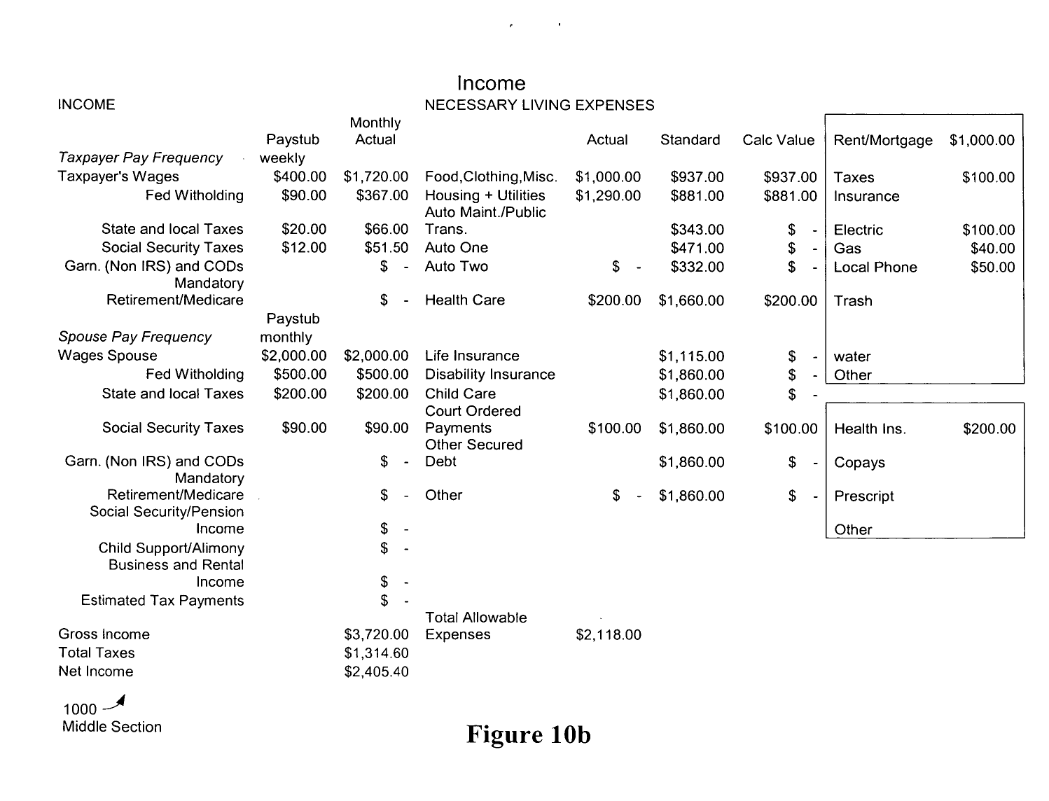

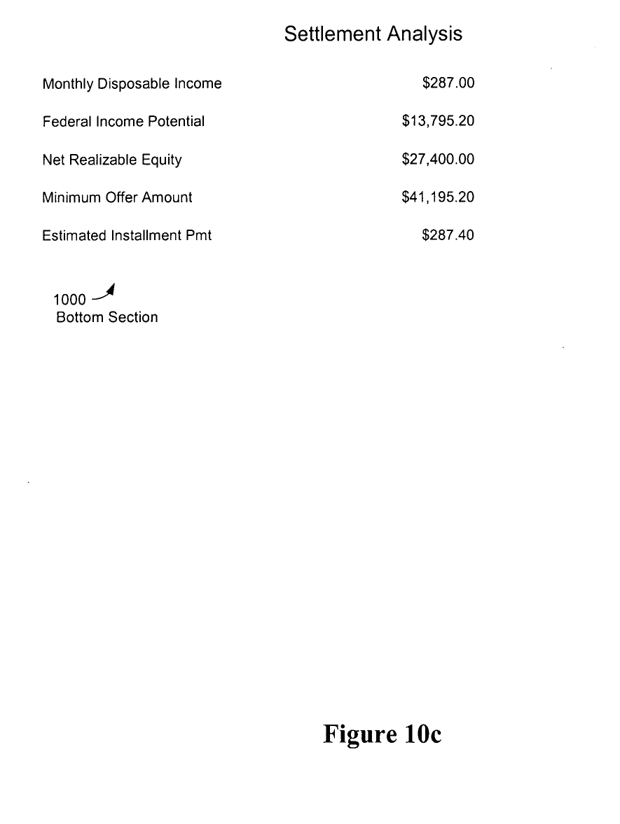

Referring back to FIG. 9, once the settlement payment option(s) is computed, the results are sent to the group manager module 108 (904 in FIG. 9). The group manager module 108 then automatically illustrates the settlement payment option(s) to the client. In one embodiment, the system 100 includes an interface of an application to show all of the information collected and the payment option automatically computed. Snapshot 1000 of FIG. 10 illustrates an interface for a specific payment option calculation example. The example interface of FIG. 10 displays the following information and how it is calculated in one embodiment based on formulae given in the table below:

| Display Item | Calculation |
|---|---|
| Monthly Disposable | Difference when total allowable living |
| Income | expenses are subtracted from the difference |
| | of gross monthly income and monthly taxes |
| | paid |
| Future Income Potential | Monthly disposable income × 48 |
| Net Realizable Equity | Total equity in assets calculated above |
| Minimum Offer Amount | Sum of Future income potential and net |
| | realizable equity |
| Estimated Installment | For tax debt balances greater than $25,000 |
| Payment | this is equal to monthly disposable income. |
| | For balances less than $25,000 it is the debt |
| | balance × 1.2 divided by 60 or Monthly |
| | Disposable income whichever is lower. If |
| | monthly disposable income is zero or less |
| | the field displays “currently non |
| | collectible-liquid assets may apply. |

In an embodiment of the present invention, the data which is displayed on the main screen may also be formatted to print a disclaimer to the taxpayer regarding the accuracy of information and the taxpayer's ability to stay in compliance with current tax obligations. Other relevant information may also be displayed on the main screen.

In one embodiment, after computing a payment option, the information may be printed by the client, allowed to be edited so as to change the computations, or submitted to the IRS for acceptance by the user and IRS.

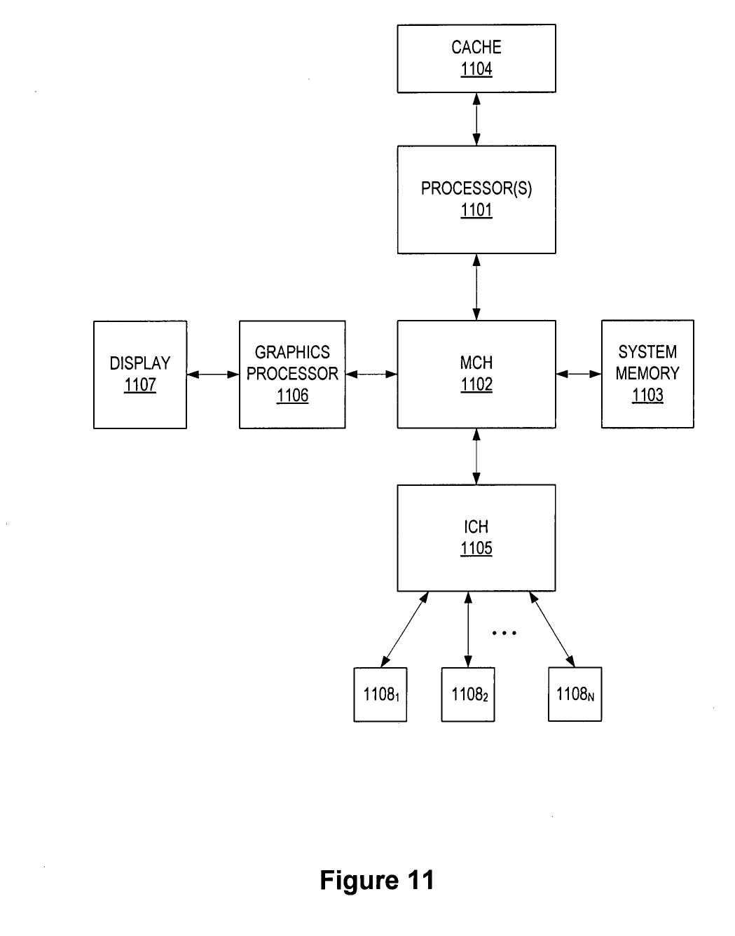

FIG. 11 shows an embodiment of a computing system (e.g., a computer). The exemplary computing system of FIG. 12 includes: 1) one or more processors 1101; 2) a memory control hub (MCH) 1102; 3) a system memory 1103 (of which different types exist such as DDR RAM, EDO RAM, etc,); 4) a cache 1104; 5) an I/O control hub (ICH) 1105; 6) a graphics processor 1106; 7) a display/screen 1107 (of which different types exist such as Cathode Ray Tube (CRT), Thin Film Transistor (TFT), Liquid Crystal Display (LCD), DPL, etc.; and/or 8) one or more I/O devices 1108.

The one or more processors 1101 execute instructions in order to perform whatever software routines the computing system implements. The instructions frequently involve some sort of operation performed upon data. Both data and instructions are stored in system memory 1103 and cache 1104. Cache 1104 is typically designed to have shorter latency times than system memory 1103. For example, cache 1104 might be integrated onto the same silicon chip(s) as the processor(s) and/or constructed with faster SRAM cells whilst system memory 1103 might be constructed with slower DRAM cells. By tending to store more frequently used instructions and data in the cache 1104 as opposed to the system memory 1103, the overall performance efficiency of the computing system improves.

System memory 1103 is deliberately made available to other components within the computing system. For example, the data received from various interfaces to the computing system (e.g., keyboard and mouse, printer port, LAN port, modem port, etc.) or retrieved from an internal storage element of the computing system (e.g., hard disk drive) are often temporarily queued into system memory 1103 prior to their being operated upon by the one or more processor(s) 1101 in the implementation of a software program. Similarly, data that a software program determines should be sent from the computing system to an outside entity through one of the computing system interfaces, or stored into an internal storage element, is often temporarily queued in system memory 1103 prior to its being transmitted or stored.

The ICH 1105 is responsible for ensuring that such data is properly passed between the system memory 1103 and its appropriate corresponding computing system interface (and internal storage device if the computing system is so designed). The MCH 1102 is responsible for managing the various contending requests for system memory 1103 access amongst the processor(s) 1101, interfaces and internal storage elements that may proximately arise in time with respect to one another.

One or more I/O devices 1108 are also implemented in a typical computing system. I/O devices generally are responsible for transferring data to and/or from the computing system (e.g., a networking adapter); or, for large scale non-volatile storage within the computing system (e.g., hard disk drive). ICH 1105 has bi-directional point-to-point links between itself and the observed I/O devices 1108.

Embodiments of the invention may include various steps as set forth above. The steps may be embodied in machine-executable instructions which cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, flash, magnetic or optical cards, propagation media or other type of media/machine-readable medium suitable for storing electronic instructions.

For example, it should be understood that in one embodiment, the present invention can be achieved by using an interactive computer environment to accomplish the above described business related purposes. Different entities may have different levels of access to different aspects of the present invention. Management may have greater access to certain levels of the interactive computer system than other entities, such as employees and/or clients. Management may be able to make contracts with clients and/or to assign tasks to employees by writing to the interactive system. The employees and/or clients, in contrast, may only have access to those functionalities in a read only mode. Moreover, employees may be able to access certain aspects of the present invention to which clients have no or lesser access.

Thus, in an embodiment of the present invention, an associated database may be created that allows management of case work in tax related environment. The software may be created using Visual Basic as the computer language, using Microsoft Access Forms as the user interface, and using MS SQL as the underlying database. However, it should be understood that other computer programs for generating the underlying software, other user interfaces, and different underlying databases can be used in the present invention. For example, other computer programming languages can be used in the present invention. Possibilities include but are not limited to ABC, ActiveX, Ada, AMOS, APL, AppleScript, Assembly, awk, BASIC, BETA, C and C++, C#, Cecil, Cilk, COBOL, cT, Curl, Delphi, Dylan, Eiffel, Forth, Fortran, Guile, Haskell, Icon, Intercal, J, Java, JavaScript, JCL, JOVIAL, Limbo, Lisp, Logo, M—MUMPS, ML, Modula-2, Modula-3, Oberon, Obliq, Occam, OpenGL, Parallel Languages, Pascal, Perl, PHP, PL/I, Pop, PostScript, Prolog, Python, Rexx, Ruby, SAS, Sather, Scheme, Scripting Languages, SDL, Self, SETL, Smalltalk, SQL, Tcl/Tk, TeX, Unified Modeling Language (UML), Verilog, Virtual Reality Modeling Language (VRML), Visual, and Z.

For example, the system uses task completion data and pre-defined case history notes for each task to provide online case tracking to clients through a Customer Portal application. By having an integration point between the data set and the Portal Application, clients will have access to the information that the business desires to make available to them. In another example, the revenue recognition and production-based compensation data may also be integrated with a financial accounting system in a seamless manner allowing for better integration, allowing for greater efficiencies. In another example, the promissory note amortization schedules may also be importable from a data set to an accounting system for each engagement, allowing greater efficiencies in billing clients.

Furthermore, the snapshots in the figures show an Microsoft® Access® interface, but it should be understood that the interface may be constructed from a variety of programming languages in a variety of forms. For example, a graphical user interface (GUI) may be created that allows a dashboard view for each client (and therefore multiple client information may be displayed at once on a display). In a further example, while snapshots in the figures may show unsecured versions of the application, it should be understood that restrictions can be places on the application that are applicable to the given user.

In a further example, many embodiments of the present invention shows tasks to be serially completed. Alternatively, tasks may be completed in parallel so that several different tasks for a particular client can be completed simultaneously. This may be important in instances where the client desires fast service. For example, if the client must file a tax return in short order, it may be desired that the tasks for that particular client be completed in parallel.

In a further example, alternative to determining defined living expense standards from a lookup table, the system may have the algorithm for determining each of the living expense standards preprogrammed with personal information and other factors being the inputs into an algorithm.

Furthermore, the present invention has been described with particular emphasis on a tax preparation business. It should be appreciated by those of skill in the art that the invention can be easily modified so as to be applicable to any of a number of business interests. With this in mind, it is contemplated and therefore within the scope of the present invention that modifications can be made to the invention without departing from the scope and spirit of the present invention.

Accordingly, the scope and spirit of the invention should be judged in terms of the claims which follow.

That which is claimed is:

1. A computer implemented method for managing a plurality of tasks on a system, comprising:
receiving a request by the system for a service;
dividing the service into an at least one task of the plurality of tasks on the system; and
assigning a subgroup of the at least one task to a specialist.

2. The computer implemented method of claim 1, further comprising:
assisting the specialist in completing the subgroup of the at least one task.

3. The computer implemented method of claim 1, further comprising:
calculating a projected completion date for a task of the subgroup; and
assigning the projected completion date for the task of the subgroup.

4. The computer implemented method of claim 3, further comprising:
supervising the completion of the task of the subgroup, wherein the task is reset and reassigned if the task is not completed by the projected completion date.

5. The computer implemented method of claim 1, further comprising:
receiving an engagement request from a prospective client;
generating an engagement letter in response to receiving an engagement request;
sending the engagement letter to the prospective client; and
receiving a signed engagement letter from the prospective client.

6. The computer implemented method of claim 1, further comprising:
assigning each of the at least one task to a service category.

7. The computer implemented method of claim 6, wherein the computer implemented method is for tax return preparation and/or tax dispute settlement and payment and further wherein service categories include a licensed professional representation, a case specialist representation, a tax return preparation, and a case intake specialist representation.

8. The computer implemented method of claim 1, wherein the specialist to assign the task to is determined by the system from an at least one factor from the group consisting of:
workload of each specialist;
a projected deadline date of the task as determined by the system;
complexity of the task;
efficiency of each specialist as computed by the system; and
deadlines of tasks in the workload of each specialist.

9. The computer implemented method of claim 2, wherein assisting the specialist in completing the subgroup includes prioritizing a workload of the specialist, the workload including a plurality of tasks to be completed by the specialist.

10. The computer implemented method of claim 9, wherein the workload is prioritized according to at least one factor from the group consisting of:
a refund risk of the engagement to each task is assigned;
a projected completion date of each task;
a monetary value of the task;
a time to complete the task; and
a relation of each task completion to a maximum profitability of all engagements.

11. The computer implemented method of claim 1, further including:
calculating from the requested service an information to be obtained from a client requesting the service for submission to the Internal Revenue Service; and
notifying the client to send the information.

12. A system for managing a plurality of tasks, comprising:
a module to receive a request by the system for a service;
a module to divide the service into an at least one task of the plurality of tasks on the system; and
a module to assign a subgroup of the at least one task to a specialist.

13. The system of claim 12, further comprising:
a module to assist the specialist in completing the subgroup of the at least one task.

14. The system of claim 12, further comprising:
a module to calculate a projected completion date for a task of the subgroup; and
a module to assign the projected completion date for the task of the subgroup.

15. The system of claim 14, further comprising:
a module to supervise the completion of the task of the subgroup, wherein the task is reset and reassigned if the task is not completed by the projected completion date.

16. The system of claim 12, further comprising a module to:
receive an engagement request from a prospective client;
generate an engagement letter in response to receiving an engagement request;
send the engagement letter to the prospective client; and
receive a signed engagement letter from the prospective client.

17. The system of claim 12, further comprising:
a module to assign each of the at least one task to a service category.

18. The system of claim 17, wherein the system is for tax return preparation and/or tax dispute settlement and payment and further wherein service categories include a licensed professional representation, a case specialist representation, a tax return preparation, and a case intake specialist representation.

19. The system of claim 12, wherein the specialist to assign the task to is determined by the system from an at least one factor from the group consisting of:
workload of each specialist;
a projected deadline date of the task as determined by the system;
complexity of the task;
efficiency of each specialist as computed by the system; and
deadlines of tasks in the workload of each specialist.

20. The system of claim 13, wherein assisting the specialist in completing the subgroup includes prioritizing a workload of the specialist, the workload including a plurality of tasks to be completed by the specialist.

21. The system of claim 20, wherein the workload is prioritized according to at least one factor from the group consisting of:
a refund risk of the engagement to each task is assigned;
a projected completion date of each task;
a monetary value of the task;
a time to complete the task; and
a relation of each task completion to a maximum profitability of all engagements.

22. The system of claim 12, further including:
calculating from the requested service an information to be obtained from a client requesting the service for submission to the Internal Revenue Service; and
notifying the client to send the information.

23. A computer implemented method for automatically determining a settlement payment option, comprising:
receiving a personal information for a client;
calculating a monthly disposable income from the personal information; and
calculating an estimated installment payment from the monthly disposable income.

24. The computer implemented method of claim 23, further comprising:
calculating a total equity in assets of the client from the personal information, wherein calculating the estimated installment payment uses the total equity in assets.

25. The computer implemented method of claim 24, further comprising:
calculating a future income potential from the monthly disposable income, wherein calculating the estimated installment payment uses the total equity in assets.

26. The computer implemented method of claim 25, further comprising:
calculating a minimum offer amount from the future income potential and the total equity in assets, wherein the minimum offer amount is used to create a counteroffer to a settlement offer from the Internal Revenue Service.

27. The computer implemented method of claim 25, wherein calculating the estimated installment payment includes:
determining if an amount owed the Internal Revenue Service is less than $25,000;
if the amount owed is not less than $25,000, setting the estimated installment payment equal to the monthly disposable income;
if the amount owed is less than $25,000, calculating the estimated installment payment to equal 1.2 times the amount owed divided by the lesser of 60 or the monthly disposable income.

28. The computer implemented method of claim 23, wherein calculating the monthly disposable income includes calculating a gross monthly income of the client less taxes and an allowable living expenses.

29. The computer implemented method of claim 28, further including calculating the allowable living expenses by totaling an amount from each living expense category designated by the Internal Revenue Service equaling the lesser of an actual expense amount or a national standard for the living expense category.

30. The computer implemented method of claim 29, further including determining the national standard for a living expense category by accessing an associative lookup table related to the living expense category.

31. The computer implemented method of claim 30, wherein the associative lookup table is indexed by a personal information affecting the national standard for the category.

32. The computer implemented method of claim 23, further including displaying the estimated installment payment on a display of the computer.

33. The computer implemented method of claim 23, further including submitting the estimated installment payment to the Internal Revenue Service.

34. A system for automatically determining a settlement payment option, comprising:
a module to receive a personal information for a client;
a module to calculate a monthly disposable income from the personal information; and
a module to calculate an estimated installment payment from the monthly disposable income.

35. The system of claim 34, further comprising:
a module to calculate a total equity in assets of the client from the personal information, wherein calculating the estimated installment payment uses the total equity in assets.

36. The system of claim 35, further comprising:
a module to calculate a future income potential from the monthly disposable income, wherein calculating the estimated installment payment uses the total equity in assets.

37. The system of claim 36, further comprising:
a module to calculate a minimum offer amount from the future income potential and the total equity in assets, wherein the minimum offer amount is used to create a counteroffer to a settlement offer from the Internal Revenue Service.

38. The system of claim 36, wherein the module to calculate the estimated installment payment includes a module to:
determine if an amount owed the Internal Revenue Service is less than $25,000;
if the amount owed is not less than $25,000, set the estimated installment payment equal to the monthly disposable income;
if the amount owed is less than $25,000, calculate the estimated installment payment to equal 1.2 times the amount owed divided by the lesser of 60 or the monthly disposable income.

39. The system of claim 34, wherein calculating the monthly disposable income includes calculating a gross monthly income of the client less taxes and an allowable living expenses.

40. The system of claim 39, further including a module to calculate the allowable living expenses by totaling an amount from each living expense category designated by the Internal Revenue Service equaling the lesser of an actual expense amount or a national standard for the living expense category.

41. The system of claim 40, further including a module to determine the national standard for a living expense category by accessing an associative lookup table related to the living expense category.

42. The system of claim 41, wherein the associative lookup table is indexed by a personal information affecting the national standard for the category.

43. The system of claim 34, further including a module to display the estimated installment payment on a display of the computer.

44. The system of claim 34, further including a module to submit the estimated installment payment to the Internal Revenue Service.
